(19) United States
(12) Patent Application Publication
(10) Pub. No.: US 2026/0340411 A1
(43) Pub. Date: Oct. 29, 2026

(54) Scientific Machine Learning Model Validation

(71) Applicant: NVIDIA Corporation, Santa Clara, CA (US)

(72) Inventors: Mohammad Amin NABIAN, San Jose, CA (US); Sanjay CHOUDHRY, Santa Clara, CA (US)

(21) Appl. No.: 19/187,959

(22) Filed: Apr. 23, 2025

(51) Int. Cl. G06N 3/096; G06N 3/0455

(52) U.S. Cl. CPC G06N 3/096; G06N 3/0455

(57) ABSTRACT

Embodiments relate to validating machine learning models for scientific simulations. A system processes training data comprising geometric shapes to generate shape-based distance metrics. Input geometric data for a machine learning model is validated by comparing shape-based characteristics against the shape-based distance metrics to determine if the input falls within a predetermined distribution range of the training data. The system selectively processes the input geometric data using the machine learning model based on this determination. The validation may include converting geometric shapes into point cloud representations, performing nearest-neighbor mapping between points, and computing average distances between mapped points. For inputs outside the acceptable range, the system may route data to a simulation service that generates simulation results for fine-tuning the model.

### TECHNICAL FIELD

The present disclosure relates to validation systems for measuring and testing the accuracy of computational models against physical laws in engineering applications.

### BACKGROUND

Computational simulations such as computational fluid dynamics (CFD), computational mechanics, and electromagnetic modeling are widely used in various engineering and scientific fields. These simulations typically require significant computational resources and processing time.

### BRIEF DESCRIPTION OF THE DRAWINGS

To easily identify the discussion of any particular element or act, the most significant digit or digits in a reference number refer to the figure number in which that element is first introduced. The present systems and methods for scientific machine learning model validation are described in detail below with reference to the attached drawing figures, wherein:

FIG. 1 is a system diagram showing a high-level view of a scientific machine learning validation framework, according to at least some embodiments of the present disclosure;

FIG. 2 is an architecture diagram showing the components of a scientific machine learning validation framework, according to at least some embodiments of the present disclosure;

FIG. 3 is a flowchart illustrating a method for processing training data to generate shape-based distance metrics, according to at least some embodiments of the present disclosure;

FIG. 4 is a flowchart illustrating a method for pre-model validation of input geometric data, according to at least some embodiments of the present disclosure;

FIG. 5 is a flowchart illustrating a method for post-model validation of machine learning outputs, according to at least some embodiments of the present disclosure;

FIG. 6 is a flowchart illustrating a method for simulation service processing within a scientific machine learning validation framework, according to at least some embodiments of the present disclosure;

FIG. 7A is a block diagram of an example generative language model system suitable for use in implementing at least some embodiments of the present disclosure;

FIG. 7B is a block diagram of an example generative language model that includes a transformer encoder-decoder suitable for use in implementing at least some embodiments of the present disclosure;

FIG. 7C is a block diagram of an example generative language model that includes a decoder-only transformer architecture suitable for use in implementing at least some embodiments of the present disclosure;

FIG. 8 is a block diagram illustrating components of a machine learning system, according to at least some embodiments of the present disclosure;

FIG. 9 is a flowchart illustrating a machine learning pipeline, according to at least some embodiments of the present disclosure;

FIG. 10 is a block diagram of an example computing device suitable for use in implementing at least some embodiments of the present disclosure; and

FIG. 11 is a block diagram of an example data center suitable for use in implementing at least some embodiments of the present disclosure.

### DETAILED DESCRIPTION

### Overview

Embodiments of the present disclosure relate to scientific machine-learning model validation. Systems and methods are disclosed for validating scientific machine learning models (SciML) models (also referred herein to as base models) used as surrogates for computationally intensive engineering simulations. This technology seeks to address reliability challenges in fields such as computational fluid dynamics, computational mechanics, and electromagnetics, for example.

Example frameworks implement a two-tier validation approach including pre-model and post-model guardrails. Input data, which may include complex three-dimensional (3D) geometries or multi-parameter operating conditions, first undergoes pre-model validation. This validation process may convert geometric inputs into point cloud representations from tessellated structures (e.g., STereoLithography (STL) files containing vertices and triangular faces).

In at least some embodiments, for geometry-driven problems, the pre-model guardrail performs nearest-neighbor mapping between points to compute average distances between geometries. These computed distances are compared against the distribution of distances from the training data to determine if a new geometry falls within acceptable bounds. The pre-model guardrail can also employ neural encoders, such as autoencoders, to generate lower-dimensional representations of complex inputs for validation purposes.

If the input passes pre-model validation, it proceeds to an inference component, for example, a cloud-native inference platform, including a base model(s), that processes the validated input. For example, the validated input is processed using Graphics Processing Unit (GPU) optimized model serving capabilities.

In at least some embodiments, following model inference, the post-model guardrail evaluates the outputs, for example, against relevant physical laws and partial differential equations (PDEs). The system may compute normalized and non-dimensionalized residuals by substituting the predicted fields into governing equations, such as Navier-Stokes for fluid flows or heat conduction equations for thermal problems.

Additional physical law checks may be performed, such as verifying symmetry properties when the input geometry exhibits symmetrical characteristics. The system can also incorporate ensemble-based uncertainty estimation to provide additional insight into prediction confidence.

In at least some embodiments, if either guardrail detects issues, the system routes the query to a simulation service. This service performs numerical simulation, to provide simulation results. The simulation results can then be used for fine-tuning the base model. For example, fine-tuning can be performed with a prediction-correction scheme that maintains the base model while training a separate correction model.

The framework may be applied across various technical domains where geometric inputs are useful, including, but not limited to:
Semiconductor design and cooling systems for thermal management;
Aerospace engineering for aerodynamic optimization;
Automotive design for drag reduction and performance enhancement;
Product design and prototyping;
Manufacturing process optimization;
Materials engineering; and
Multi-physics simulations.

In at least some embodiments, the technology operates as a modular system where each validation component can function independently while contributing to a validation pipeline. This approach seeks to provide early detection of potential issues through pre-model validation, verification of physical consistency through post-model validation, or both.

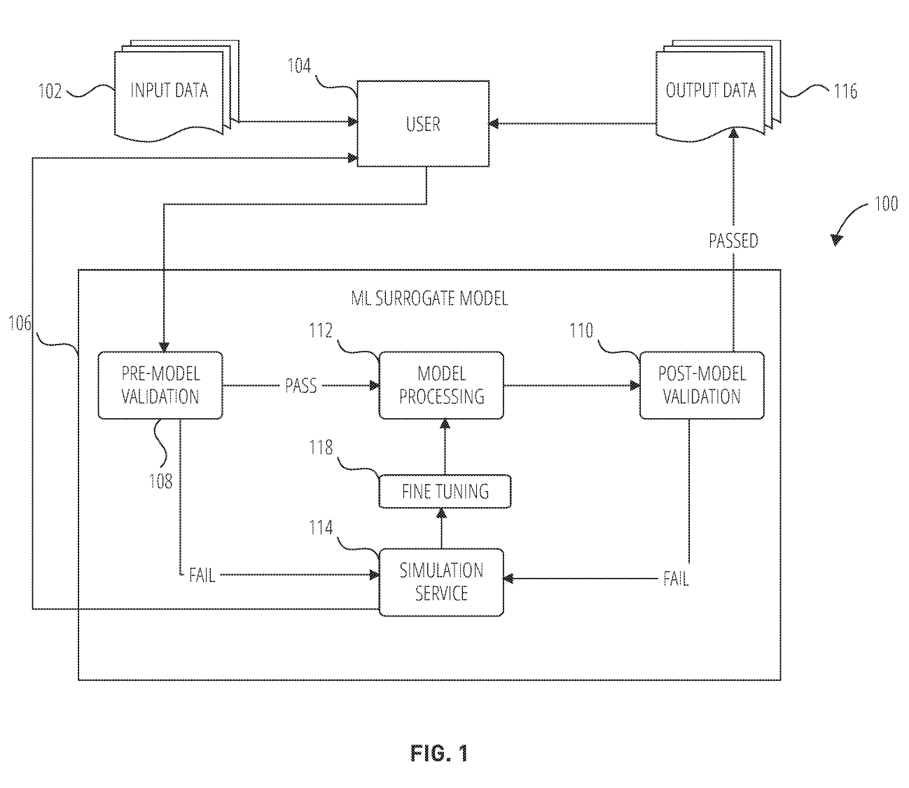

### FIG. 1

FIG. 1 is a system diagram showing a high-level view of a scientific machine learning validation framework 100, according to some embodiments. The following description provides an introductory overview of system components and operations, with more detailed functionality and operations being described in subsequent figures.

FIG. 1 shows that input data 102 may be provided by a user device (and, by extension, a user 104) to a machine learning (ML) surrogate model 106. The ML surrogate model 106 may be used for accelerating computationally intensive engineering simulations such as computational fluid dynamics (CFD), computational mechanics, or electromagnetics.

In some embodiments, the ML surrogate model 106 may be implemented or may otherwise include using various machine learning architectures designed to approximate complex engineering simulations. The ML surrogate model 106, in some examples, includes or is communicatively coupled to one or more of pre-model validation 108, post-model validation 110, model processing 112 (e.g., by a base model), fine tuning 118, and a simulation service 114.

The ML surrogate model 106 may include regression-based models such as polynomial regression, Gaussian process models (also known as Kriging), or radial basis functions that capture the input-output relationships of the original simulation. In other embodiments, the ML surrogate model 106 may utilize neural network architectures, including feedforward networks, convolutional neural networks, or graph neural networks, particularly effective for capturing complex geometric relationships in computational fluid dynamics, computational mechanics, or electromagnetics simulations.

In some embodiments, the input data 102 may include complex three-dimensional geometric shapes that serve as inputs to ML surrogate model 106. For aerodynamic simulations, these may include detailed tessellated geometries of various vehicle designs such as sedans, trucks, or specialized automotive components, represented as STL (STereoLithography) files containing vertices and triangular faces that define the surface geometry. The ML surrogate model 106 may process these geometries as point clouds for comparison and validation purposes.

For mechanical structures undergoing stress analysis, the input data 102 may comprise computer-aided design (CAD) models of structural components, deformable bodies, or mechanical assemblies. These structures can be converted into point cloud representations for geometric validation prior to simulation.

In electromagnetics applications, the input data 102 may include geometric representations of electromagnetic components such as antennas, waveguides, or circuit elements. These electromagnetic structures may similarly be processed as tessellated geometries with vertices, edges, and triangular faces, which can be analyzed using the shape descriptor approach to determine their similarity to training data geometries before processing by the ML surrogate model 106.

In some embodiments, the framework 100 implements a dual guardrail framework comprising a pre-model validation 108 and a post-model validation 110, with model processing 112 occurring between these validation stages. At a high level, the pre-model validation 108 evaluates whether the input data 102 falls within an acceptable distribution range of the training data by comparing shape-based characteristics. If the pre-model validation 108 fails, the input data 102 is routed to a simulation service 114.

Similarly, after model processing 112, the post-model validation 110 evaluates the output data 116 of the model processing 112 by checking adherence to physical laws, such as conservation of mass or energy, using normalized partial differential equation (PDE) residuals. If the post-model validation 110 fails, the data is also routed to the simulation service 114.

In some embodiments, the model processing 112 may be performed by a base model in the example form of an inference execution component. At a high level, this inference execution component serves as a runtime environment that executes a validated machine learning model(s) (e.g., base model(s)) to generate predictions for scientific simulations. The inference execution processing component receives input data 102 that has passed through the pre-model validation 108 and performs computational inference operations.

In some embodiments, the model processing component may implement a containerized microservices architecture that dynamically selects and orchestrates the most appropriate inference engines based on the specific hardware configuration and model characteristics. This component may leverage hardware acceleration through specialized libraries that optimize tensor operations. The processing pipeline automatically handles batching, memory management, and computational graph optimization.

A simulation service 114 performs high-fidelity simulations that, while more computationally expensive, provide reliable results for inputs that fall outside the base (e.g., ML) model's reliable prediction range. Results from the simulation service 114 can be used for fine tuning 118 the base model (e.g., inference execution component), creating a feedback loop that improves the base model over time.

This framework 100 seeks to address the technical problem of ensuring reliability in scientific machine learning models by validating both inputs and outputs against physical constraints, particularly for complex geometric inputs in fields such as aerodynamics, semiconductor cooling, and design optimization applications.

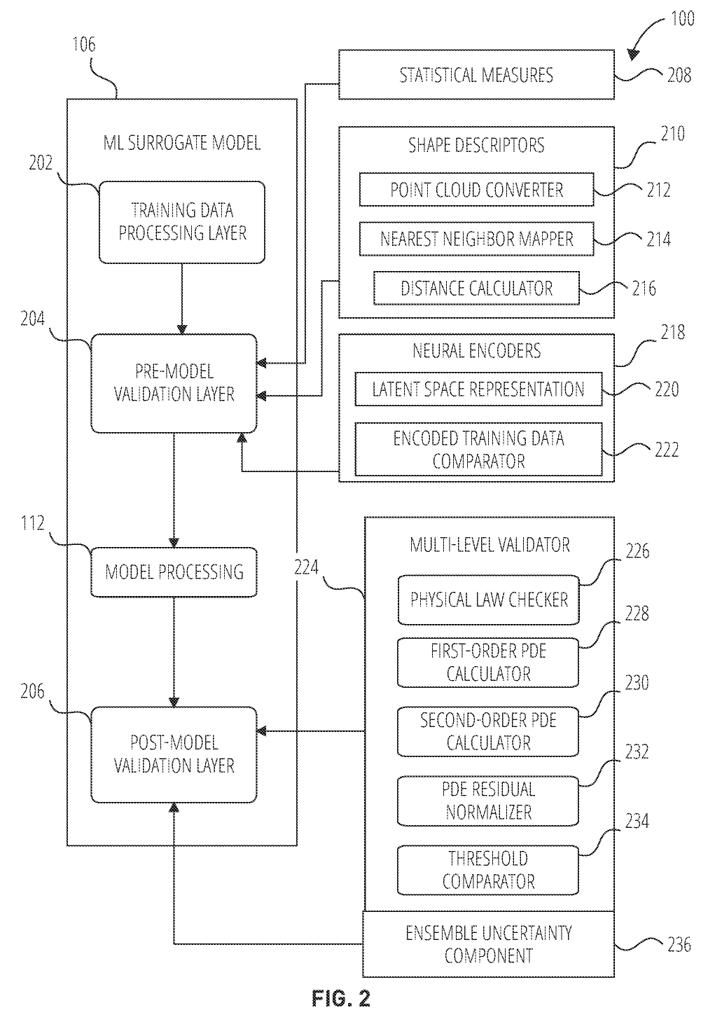

### FIG. 2

FIG. 2 is an architecture diagram showing the components of a scientific machine learning validation framework 100, according to some embodiments. More detailed operations of these components are described in subsequent flow charts.

The ML surrogate model 106 of FIG. 1 is illustrated in FIG. 2. The architecture of the ML surrogate model 106 comprises functional layers:
a training data processing layer 202, a pre-model validation layer 204, model processing 112, and a post-model validation layer 206. These layers (and their corresponding components) may work together to implement a dual guardrail system for ensuring reliability in scientific machine learning applications.

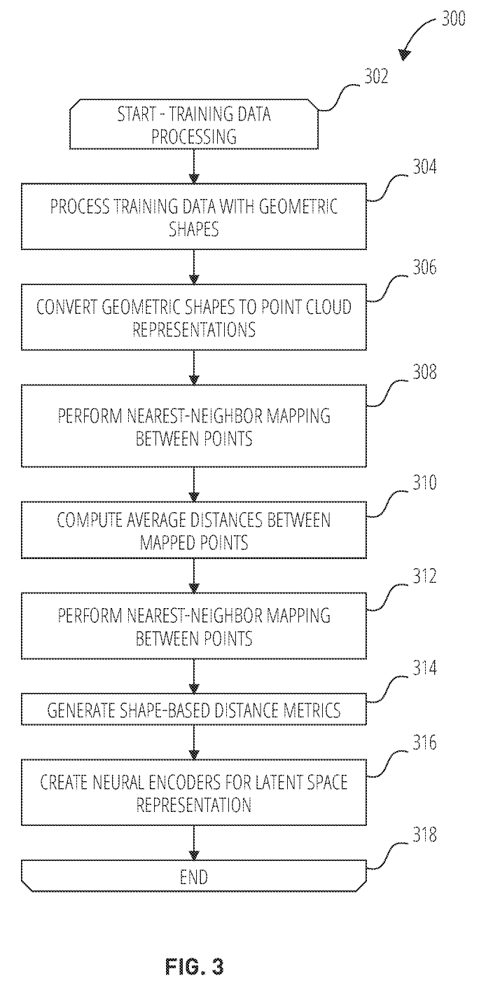

In some embodiments, the training data processing layer 202 serves as a preparatory component for the pre-model validation layer 204. The training data processing layer 202, in some embodiments, processes geometric training data to generate the shape-based distance metrics and neural encoders used by the pre-model validation layer 204. The training data processing layer 202 provides these metrics to the pre-model validation layer 204, enabling it to assess whether new input geometric data falls within an acceptable distribution range of the training data. The detailed operations of this training data processing layer are described in connection with FIG. 3.

The pre-model validation layer 204 may incorporate one or more pre-model validation approaches for input data assessment. The pre-model validation approach(es) may include statistical measures 208. The statistical measures 208 may provide fundamental parameter validation capabilities that, in some embodiments, may include range checks for scalar inputs such as velocities or temperatures. The pre-model validation approach(es) may include shape descriptors 210. The shape descriptors 210 implement geometric validation through several specialized components. For example, a point cloud converter 212 may transform complex geometric inputs into point cloud representations which, in some embodiments, may involve converting tessellated geometries such as STL files containing vertices and triangular faces into analyzable point structures. For another example, a nearest neighbor mapper 214 may establish correspondence between geometric elements by, in some embodiments, performing pairwise mapping between points of different geometries to identify structural similarities. For yet another example, a distance calculator 216 may quantify geometric differences by, in some embodiments, computing average distances between mapped points to determine how significantly a new geometry deviates from training examples.

The pre-model validation approach(es) may include neural encoders 218. The neural encoders 218, in some embodiments, provide a validation methodology through dimensional reduction techniques. Latent space representation 220 maps high-dimensional geometric data to a lower-dimensional manifold which, in some embodiments, involves autoencoder networks that capture geometric features. An encoded training data comparator 222 evaluates similarity in this compressed representation space by, in some embodiments.

The post-model validation layer 206 may implement a multi-level validator 224 that performs progressive physical law verification. The multi-level validator 224 may include a physical law checker 226, a first-order PDE calculator 228, a second-order PDE calculator 230, a PDE residual normalizer 232, and a threshold comparator 234. The physical law checker 226 may verify fundamental properties which, in some embodiments, may include symmetry validation for symmetric structures or basic conservation principles. For more rigorous validation, the first-order PDE calculator 228 and the second-order PDE calculator 230 may compute derivatives for governing equations including, for example, continuity equations (first-order) and momentum equations (second-order) for fluid dynamics applications. The PDE residual normalizer 232 may standardize these measurements by scaling residuals to enable consistent interpretation across different problem scales and parameter regimes. The threshold comparator 234 may evaluate validation results against configurable criteria which, in some embodiments, are adjusted based on application-specific accuracy requirements.

An ensemble uncertainty component 236 may augment the validation process by, in some embodiments, providing statistical confidence measures for model predictions through ensemble methods or uncertainty quantification techniques.

This architecture enables comprehensive validation of scientific machine learning models across domains including, for example, computational fluid dynamics, computational mechanics, and electromagnetics simulations.

### FIG. 3

FIG. 3 is a flowchart illustrating a method 300 for processing training data to generate shape-based distance metrics, according to at least some embodiments.

In at least some embodiments, the training data processing method 300, as performed by the training data processing layer 202, serves as a preparatory phase within the scientific machine learning validation framework 100 shown in FIG. 1, establishing the foundation for the pre-model validation 108. This process generates the shape-based distance metrics and neural encoders that enable the pre-model validation 108 component to effectively assess whether new input data 102 falls within an acceptable distribution range of the training data. By processing geometric training data to establish baseline metrics for comparison, this method 300 creates the foundation for detecting out-of-distribution inputs before they reach model processing 112 and/or the base model, thereby preventing potentially unreliable predictions. The metrics generated through this process are stored and later accessed during the pre-model validation phase to ensure that only suitable inputs proceed to model processing 112.

The method 300 commences at block 302 with the initiation of a training data processing operation. In some embodiments, this operation may be performed by a computational system (e.g., within the training data processing layer 202) configured to analyze geometric training data for scientific machine learning applications such as computational fluid dynamics, computational mechanics, or electromagnetics simulations.

At block 304, the training data processing layer 202 processes training data containing geometric shapes. In some embodiments, this may involve analyzing complex 3D structures such as vehicle designs for aerodynamic simulations, where the system extracts relevant geometric features from multiple design examples to establish a baseline for comparison.

At block 306, the training data processing layer 202 converts geometric shapes to point cloud representations. In some embodiments, this conversion may transform tessellated geometries such as STereoLithography (STL) files containing vertices and triangular faces into collections of points in three-dimensional space. This enables the system to treat the geometries as point clouds for mathematical analysis of shape characteristics.

At block 308, the training data processing layer 202 performs nearest-neighbor mapping between points. In some embodiments, this operation may implement spatial search algorithms to identify corresponding points between different geometries. The ML surrogate model 106 places geometries at the same origin before performing this mapping, which establishes a consistent reference frame for comparing different shapes.

At block 310, the training data processing layer 202 computes average distances between mapped points. In some embodiments, this calculation quantifies the geometric differences between corresponding points, generating statistical measures of shape variation. For example, when comparing different vehicle designs, the average distance between mapped points provides a quantifiable metric of geometric similarity. When comparing a sedan with another sedan, the average distance would be relatively small, whereas comparing a sedan with a truck would yield a much larger average distance, indicating significant geometric differences. This enables the system to distinguish between different classes of shapes and determine whether a new design falls within the distribution of shapes on which the model was trained.

At block 312, the training data processing layer 202 performs additional nearest-neighbor mapping between points. In some embodiments, this operation may refine the initial mapping to improve correspondence accuracy, particularly for geometries with complex features or significant variations.

At block 314, the training data processing layer 202 generates shape-based distance metrics. In some embodiments, these metrics incorporate statistical distributions of point-to-point distances across the training dataset. The system computes a distribution of average distances between training samples, establishing confidence boundaries that can be used to determine whether new inputs are within or outside the training distribution. This distribution analysis provides a statistical foundation for the pre-model validation by quantifying the range and variability of geometric features present in the training data.

At block 316, the training data processing layer 202 creates neural encoders for latent space representation. In some embodiments, these encoders may implement autoencoder neural network architectures that learn to compress high-dimensional geometric data into lower-dimensional manifolds. This provides a validation approach where, in addition to or instead of comparing geometries in physical space through point-wise distances, the system can measure distances in the latent space after mapping geometries through the encoder.

At closing loop block 318, the method 300 concludes, having established the computational foundation for pre-model validation of geometric inputs. The metrics and encoders generated through this process may be used by the pre-model validation 108 component and/or the pre-model validation layer 204 to assess whether new input data falls within an acceptable distribution range of the training data, preventing potentially unreliable predictions from the ML surrogate model 106.

Although the example method 300 depicts a particular sequence of operations, the sequence may be altered without departing from the scope of the present disclosure. For example, some of the operations depicted may be performed in parallel or in a different sequence that does not materially affect the function of the method 300. In some embodiments, different components of an example device or system that implements the method 300 may perform functions at substantially the same time or in a specific sequence.

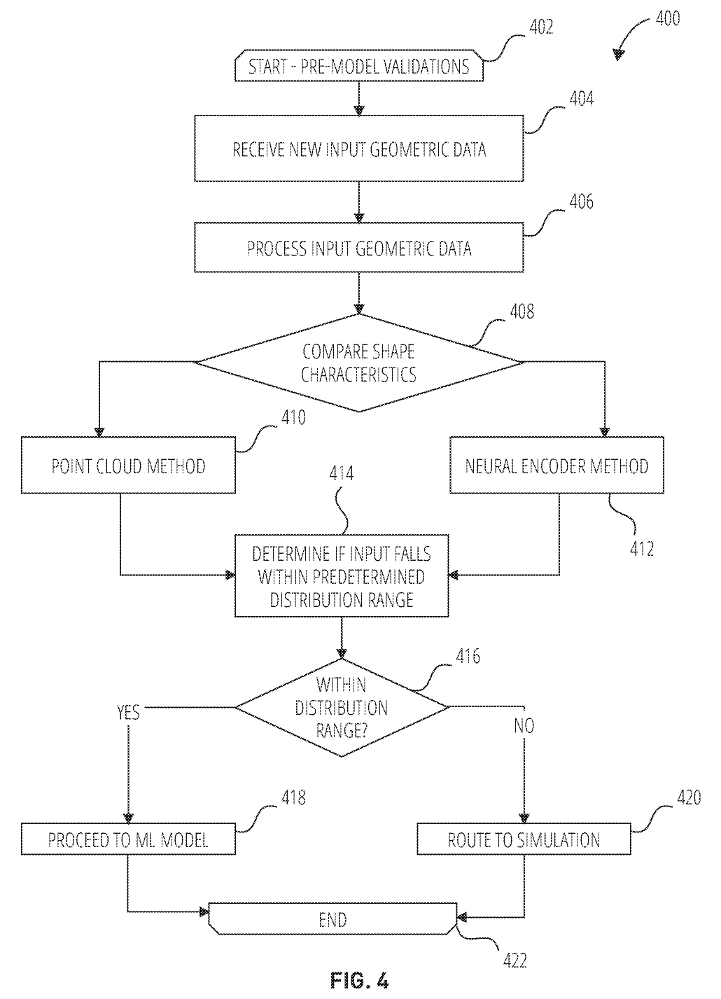

### FIG. 4

FIG. 4 is a flowchart illustrating a method 400 for pre-model validation of input geometric data, according to some embodiments. The method 400 illustrated in FIG. 4 represents an operational component within the scientific machine learning validation framework 100 shown in FIG. 1. For example, this pre-model validation process serves as the first guardrail in the dual guardrail architecture detailed in FIG. 2. While the training data processing method 300 (FIG. 3) establishes a foundation by generating shape-based distance metrics from geometric training data, method 400 applies these metrics to validate new input data before it reaches the base model for model processing 112.

The pre-model validation process leverages the shape descriptors 210 and neural encoders 218 shown in FIG. 2, including the point cloud converter 212, nearest neighbor mapper 214, distance calculator 216, latent space representation 220, and/or the encoded training data comparator 222, to determine whether new geometric inputs fall within an acceptable distribution range of the training data. In some embodiments, this validation is particularly helpful for complex three-dimensional structures in computational fluid dynamics, computational mechanics, and electromagnetics simulations, for example, where geometric similarity to training data is essential for reliable predictions.

At block 402, the ML surrogate model 106 initiates the pre-model validation process. The pre-model validation layer 204 is the first guardrail in the scientific machine learning validation framework 100 shown in FIG. 1, operating on input data 102 before it reaches the base model.

At block 404, the pre-model validation layer 204 receives new input data 102 that includes geometric data. This layer processes geometric structures such as vehicle designs for aerodynamic simulations, mechanical components for stress analysis, or electromagnetic structures that require validation. The input data 102 may include tessellated STereoLithography (STL) files containing vertices, edges, and triangular faces that represent complex shapes.

At block 406 the pre-model validation layer 204 processes the input geometric data. This may include preparing the geometric data for comparison with training data metrics by converting the input geometry data into formats suitable for shape analysis. For example, this may include extracting relevant geometric features or normalize the geometric data to ensure consistent comparison with training examples.

At decision block 408, the pre-model validation layer 204 performs a decision operation to determine which shape comparison method to use. This may include selecting between a point cloud method or a neural encoder method based on the type of geometric data, available computational resources, or specific requirements of the application domain.

At block 410, assuming the point cloud method was selected, the point cloud converter 212 and related components implement the point cloud method for shape comparison. These components convert the input geometry into a point cloud representation, place it at the same origin as reference geometries from the training data, and perform nearest-neighbor mapping between points. For example, when validating a new car design, the nearest neighbor mapper 214 maps corresponding points between the new design and training examples to establish geometric correspondence.

At block 412, assuming the neural encoder method was selected, the neural encoders and related components implement the neural encoder method for shape comparison. These components utilize autoencoder neural networks to map the input geometry to a lower-dimensional latent space representation 220, where the encoded training data comparator 222 can measure distances more efficiently while preserving essential shape characteristics.

At block 414, depending on the shape comparison method used, either the distance calculator 216 or encoded training data comparator 222 determines if the input falls within a predetermined distribution range. These components compare the computed geometric distances or latent space representations against the distribution of distances observed in the training data. For example, the distance calculator 216 calculates whether the average distance between the new geometry and reference geometries exceeds a predetermined variation seen among training samples, distinguishing, for example, between sedans and trucks based on their geometric differences.

At decision block 416, the pre-model validation layer 204 performs a decision operation based on the distribution range assessment of block 414. This may include applying configurable thresholds that can be adjusted based on application-specific accuracy requirements or user preferences.

At block 418, if the input data 102 is determined to fall within the acceptable distribution range, the pre-model validation layer 204 passes the data to model processing 112 (e.g., base model). This determination indicates that the geometric input is sufficiently similar to the training data, suggesting that the base model can produce reliable predictions.

At block 420, if the input data is determined to fall outside the acceptable distribution range, the pre-model validation layer 204 routes the data to the simulation service 114. The simulation service 114 may trigger a high-fidelity simulation that, while more computationally expensive, provides more reliable results for inputs that differ significantly from the training distribution.

At closing loop block 422, the method 400 concludes, having either validated the input for model processing 112 or redirected it to the simulation service based on its geometric characteristics.

Although the example method 400 depicts a particular sequence of operations, the sequence may be altered without departing from the scope of the present disclosure. For example, some of the operations depicted may be performed in parallel or in a different sequence that does not materially affect the function of the method 400. In some embodiments, different components of an example device or system that implements the method 400 may perform functions at substantially the same time or in a specific sequence.

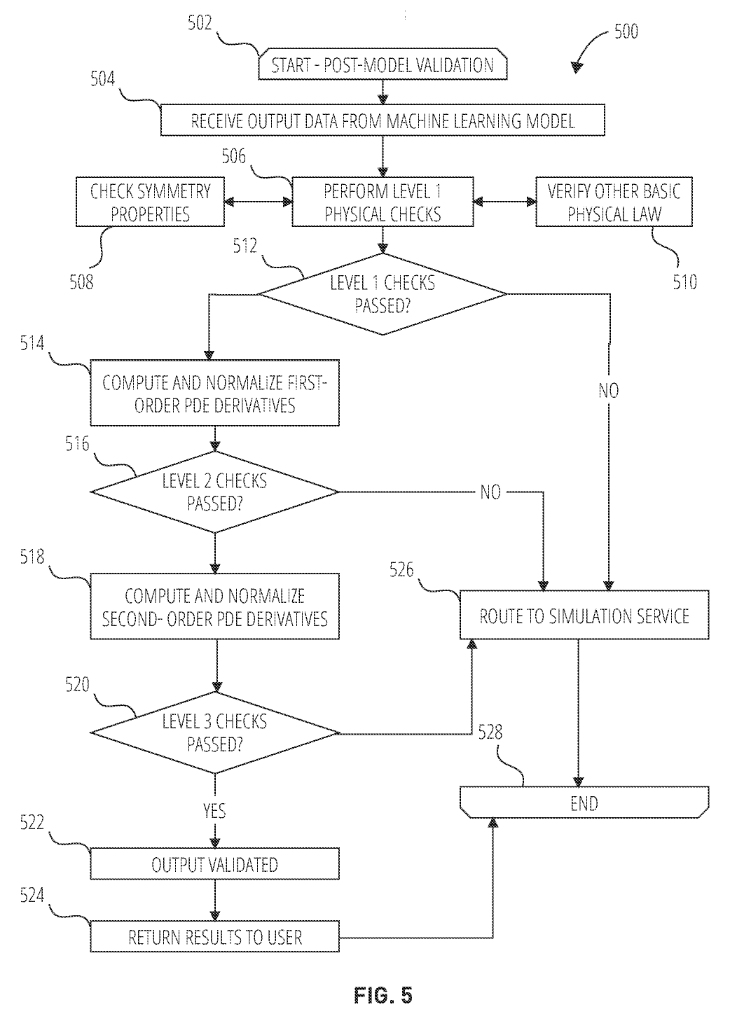

### FIG. 5

FIG. 5 is a flowchart illustrating a method 500 for post-model validation of machine learning outputs, according to at least some embodiments. This method implements the post-model validation 110 shown in FIG. 1, serving as the second guardrail in the dual guardrail framework. While previous figures established the overall system architecture (FIG. 1), component details (FIG. 2), training data processing (FIG. 3), and pre-model validation (FIG. 4), this figure focuses on the post-processing validation that checks physical plausibility of model predictions after they have been generated.

The method 500 begins at opening loop block 502 with the initiation of the post-model validation process by the post-model validation layer 206. This process operates after the base model has generated predictions but before those predictions are returned to the user 104.

At block 504, the post-model validation layer 206 receives output data 116 from model processing 112 (e.g., the base model). In some embodiments, this output data 116 may include predicted flow fields for aerodynamic simulations, stress distributions for mechanical analyses, or electromagnetic field distributions, for example.

At blocks 506, 508, and 510, the physical law checker 226 performs Level 1 physical checks, which represent computationally lightweight validations. At block 506, the physical law checker 226 checks symmetry properties of the output data 116, which in some embodiments may involve comparing corresponding points across planes of symmetry to verify that predicted values maintain expected symmetry relationships. For example, in aerodynamic simulations of symmetric vehicle designs, the pressure distribution on one side should ideally mirror the distribution on the opposite side within acceptable numerical tolerances.

At block 508, the physical law checker 226 performs additional Level 1 physical checks that may include conservation principles verification using the output data 116. In some embodiments, these checks may examine whether basic conservation laws are maintained, such as verifying that the total energy in electromagnetic simulations remains constant or that mass is conserved in fluid dynamics predictions.

At block 510, the physical law checker 226 verifies other basic physical laws using the output data 116. These checks may be domain-specific and in some embodiments may include checking that predicted temperatures remain above absolute zero, that predicted pressures remain positive, or that predicted velocities do not exceed physically reasonable limits for the application domain.

In some embodiments, the physical law checker 226, at blocks 506 – 510, performs physical property verification operations requiring lower computational complexity (e.g., O(n) computational complexity, where n represents the number of data points in the output data). These operations may include symmetry verification, conservation principle checks, and basic boundary condition validation, which require only a single pass through the output data. These physical property verification operations are computationally less expensive than first-order PDE derivatives and second or higher order PDE derivatives, which require progressively more computational resources.

At decision block 512, the threshold comparator 234 determines whether the Level 1 checks have passed by comparing the results from the physical law checker 226 against configurable thresholds. In some embodiments, this determination may involve comparing computed deviations against thresholds that can be adjusted based on application requirements. For example, symmetry violations might be allowed up to 0.1 % difference for aerodynamic applications but may need stricter 0.01 % compliance for precision electromagnetic simulations.

If the Level 1 checks fail, the method 500 follows the "NO" path directly to block 526, where the post-model validation layer 206 routes the output data 116 to the simulation service 114. If the checks pass, the method 500 continues to block 514.

At block 514, the first-order PDE calculator 228 computes and the PDE residual normalizer 232 normalizes first-order PDE derivatives using the output data 116. In some embodiments, this involves the first-order PDE calculator 228 calculating spatial derivatives of the predicted fields and substituting them into the governing equations. For fluid dynamics applications, this may include computing the divergence of the velocity field to verify mass conservation (continuity equation). The PDE residual normalizer 232 then processes these raw residuals by dividing them by characteristic scales appropriate to the problem domain, such as freestream velocity for aerodynamics or reference temperature for thermal problems, enabling consistent interpretation across different simulation scales and parameter regimes. This normalization may be helpful because without it, the scale of residuals may vary significantly across different problem sizes and operating conditions, making it challenging to establish universal thresholds for validation.

At decision block 516, the threshold comparator 234 determines whether the Level 2 checks have passed by comparing the normalized first-order PDE residuals against predetermined thresholds. In some embodiments, these thresholds may be established based on validation studies that correlate residual magnitudes with prediction accuracy. For example, continuity equation residuals below 10^-3 might be considered acceptable for automotive aerodynamics applications, while more demanding aerospace applications might require residuals below 10^-4.

If the Level 2 checks fail, the method 500 follows the "NO" path to block 526. If they pass, the method 500 continues to block 518.

At block 518, the second-order PDE calculator 230 computes and the PDE residual normalizer 232 normalizes second and higher order PDE derivatives using the output data 116, which may involve more computationally intensive calculations. In some embodiments, for fluid dynamics applications, this may include the second-order PDE calculator 230 computing the Laplacian terms in the momentum equations (Navier-Stokes) to verify momentum conservation. The PDE residual normalizer 232 then processes these higher-order terms using techniques such as, for example, dimensionless scaling factors based on Reynolds number for fluid dynamics or material property ratios for structural mechanics.

At decision block 520, the threshold comparator 234 determines whether the Level 3 checks have passed by comparing the normalized second-order PDE residuals against predetermined thresholds. In some embodiments, these thresholds may be more permissive than those for first-order terms, acknowledging the increased numerical sensitivity of higher-order derivatives. For example, momentum equation residuals below 10^-2 might be considered acceptable for general engineering applications.

If the Level 3 checks fail, the method 500 follows the "NO" path to block 526. If they pass, the method 500 continues to blocks 522 and 524.

At block 522, the post-model validation layer 206 marks the output data 116 as validated, indicating that the predictions satisfy physical constraints within acceptable tolerances.

At block 524, the post-model validation layer 206 returns the validated results to the user 104 and, in some embodiments, including confidence metrics derived from the residual magnitudes to indicate prediction reliability. For example, the user 104 is presented with the validated results in a user interface displayed by their user device.

At block 526, if any validation level fails, the post-model validation layer 206 routes the output data 116 to the simulation service 114 for high-fidelity simulation processing.

At block 528, the method 500 concludes, having either validated the ML model outputs (e.g., output data 116) as physically plausible or redirected the query to the simulation service for more reliable processing.

Although the example method 500 depicts a particular sequence of operations, the sequence may be altered without departing from the scope of the present disclosure. For example, some of the operations depicted may be performed in parallel or in a different sequence that does not materially affect the function of the method 500. In some embodiments, different components of an example device or system that implements the method 500 may perform functions at substantially the same time or in a specific sequence.

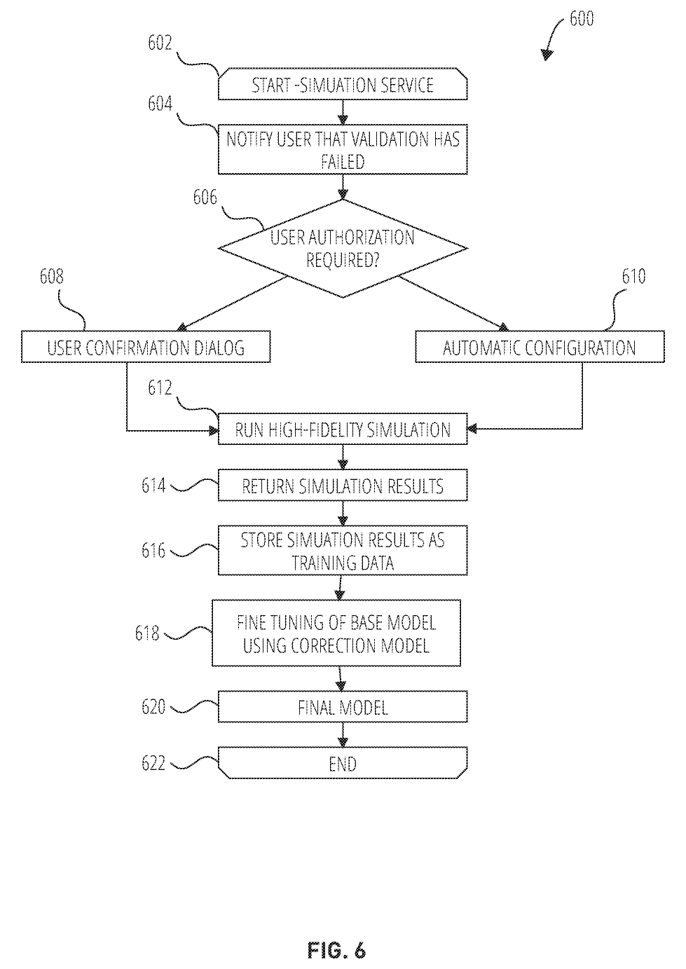

### FIG. 6

FIG. 6 is a flowchart illustrating a method 600 for simulation service processing within a scientific machine learning validation framework, according to at least some embodiments. This method represents the operations performed by the simulation service 114 shown in FIG. 1, which is triggered when either the pre-model validation 108 or post-model validation 110 determines that input data or model outputs fall outside acceptable parameters.

The simulation service 114 completes the dual guardrail framework established in the preceding figures. While FIG. 1 introduced the overall system architecture with pre-model validation 108 and post-model validation 110 components, FIG. 2 detailed the specific components of these validation layers, FIG. 3 illustrated the training data processing that establishes validation metrics, FIG. 4 showed the pre-model validation process for geometric inputs, and FIG. 5 depicted the post-model validation for physical law adherence. FIG. 6 now illustrates what happens when validation fails, completing a feedback loop that allows the framework 100 to handle, for example, out-of-distribution inputs or physically implausible outputs through high-fidelity simulation and model improvement.

At opening loop block 602, the simulation service 114 begins with the initiation of the simulation service process. In some embodiments, this service may be implemented as a computational system configured to perform high-fidelity simulations for inputs that have been flagged as potentially problematic by the validation guardrails.

At block 604, the simulation service 114 notifies the user 104 that validation has failed, using data from either the pre-model validation 108 or post-model validation 110 components. In some embodiments, this notification may include specific information about which validation check failed and why, providing transparency about the decision to route the query to the simulation service rather than processing it with the base model.

At decision block 606, the simulation service 114 determines whether user authorization is required before proceeding with the simulation, based on system configuration data. In some embodiments, this decision may be based on configurable system settings that balance computational resource management with user control, allowing organizations to implement policies appropriate for their specific needs and computational constraints. Users may configure the system to automatically route queries to the simulation service without requiring permission for each instance, or to prompt for authorization on a case-by-case basis.

At block 608, if user authorization is required, the simulation service 114 presents a user confirmation dialog to the user 104. In some embodiments, this dialog may include estimated computational costs and processing time to help the user make an informed decision about whether to proceed with the more resource-intensive simulation.

At block 610, if user authorization is not required, the simulation service 114 applies automatic configuration settings from predefined system parameters. In some embodiments, these settings may include predefined parameters for simulation resolution, convergence criteria, and other technical specifications that have been selected for the specific application domain.

At block 612, the simulation service 114 runs a high-fidelity simulation using the input data 102 that failed validation. In some embodiments, this may involve solving the governing equations using numerical methods such as finite volume, finite element, or finite difference approaches, depending on the specific physics being modeled. For example, in computational fluid dynamics applications, this might involve solving the complete Navier-Stokes equations with appropriate turbulence models and boundary conditions.

At block 614, the simulation service 114 returns the simulation results to the user 104 (e.g., by presenting the simulation results in a user interface at a user device of the user 104). In some embodiments, these results may include not only the primary outputs but also additional diagnostic information that helps validate the simulation's accuracy and convergence.

At block 616, the simulation service 114 stores the simulation results as training data in a data storage system. In some embodiments, this operation may involve preprocessing the simulation outputs to extract features relevant to machine learning, normalizing the data, and integrating it into the existing training dataset with appropriate metadata to track its origin.

At block 618, fine tuning 118 performs or otherwise includes fine-tuning of the base model (e.g., the ML model) using a correction model approach with the simulation results data. In some embodiments, this implements a prediction-correction scheme where, instead of directly modifying the base model parameters, a separate correction model is trained to adjust the outputs of the base model. This approach maintains the stability of the base model while allowing for incremental improvements based on new simulation data. The correction model may be implemented using the same architecture as the base model or with a different architecture optimized for capturing the specific types of errors observed in the base model's predictions.

At block 620, fine tuning 118 produces a final, revised model by combining the base model (e.g., ML model) with the correction model. In some embodiments, the final model is the sum of the base model output and the correction model output, effectively creating a more accurate composite model without destabilizing the original training. This prediction-correction approach differs from fine-tuning methods that directly modify the base model parameters, either all parameters or a specific subset while freezing others.

At block 622, the method 600 concludes, having processed the simulation request, returned results to the user, and updated the ML surrogate model 106 to improve future predictions.

Although the example method 600 depicts a particular sequence of operations, the sequence may be altered without departing from the scope of the present disclosure. For example, some of the operations depicted may be performed in parallel or in a different sequence that does not materially affect the function of the method 600. In some embodiments, different components of an example device or system that implements the method 600 may perform functions at substantially the same time or in a specific sequence.

Now referring to FIGS. 3 - 6, each block of methods 300, 400, 500, and 600, described herein, comprises a computing process that may be performed using any combination of hardware, firmware, and/or software. For instance, various functions may be carried out using one or more processors executing instructions stored in one or more memories. The methods 300-600 may also be embodied as computer-usable instructions stored on computer storage media. The methods may be provided by a standalone application, a service or hosted service (standalone or in combination with another hosted service), as a microservice via an application programming interface (API) or a plug-in to another product, to name a few. In addition, methods 300-600 are described, by way of example, with respect to the system of FIGS. 1 and 2. However, these methods may additionally or alternatively be executed by any one system, or any combination of systems, including, but not limited to, those described herein.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models – such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems using or deploying one or more inference microservices, systems that incorporate one or more machine learning models deployed in a service or microservice along with an OS level virtualization package, systems implemented at least partially using cloud computing resources, and/or other types of systems.

### EXAMPLE LANGUAGE MODELS

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases) – such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs – such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures – such as those that rely on self-attention and/or cross-attention (e.g., between contextual data and textual data) mechanisms – may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type – including but not limited to those described herein – may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not need task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models – or layers thereof – may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires or benefits from a mathematical computation, the model may access one or more math plug-ins or APIs for help in solving the problem(s) and may then use the response from the plug-in and/or API in the output from the model. This process may be repeated – e.g., recursively – for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources – such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models, e.g., language models with different architectures and language models trained on different (e.g., updated) corpora of data, may be provided with the same input query and prompt (e.g., set of constraints, conditioners, etc.). In one or more embodiments, the language models may be different versions of the same foundation model. In one or more embodiments, at least one language model may be instantiated as multiple agents – e.g., more than one prompt may be provided to constrain, direct, or otherwise influence a style, a content, or a character, etc., of the output provided. In one or more examples, non-limiting embodiments, the same language model may be asked to provide output corresponding to a different role, perspective, character, or having a different base of knowledge, etc. – as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model – or version, instance, or agent – may be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

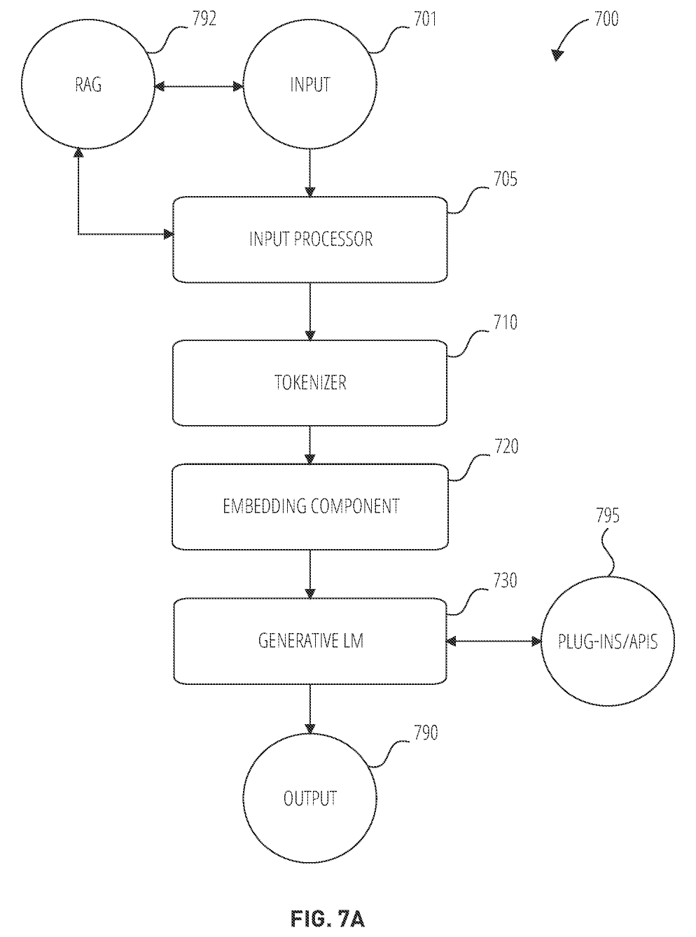

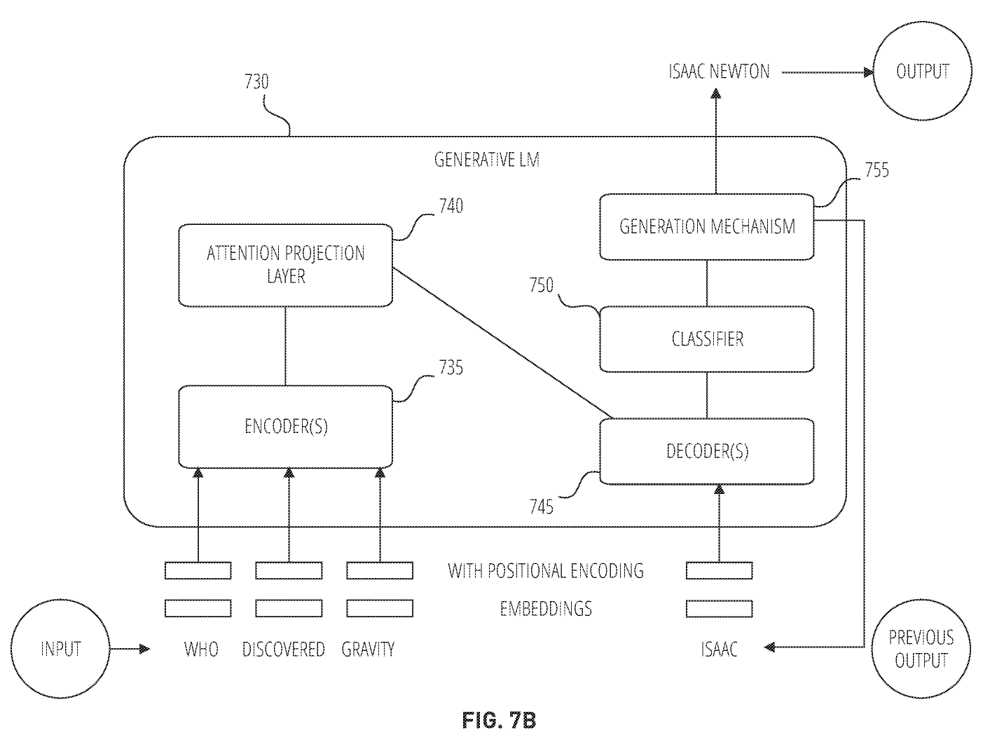

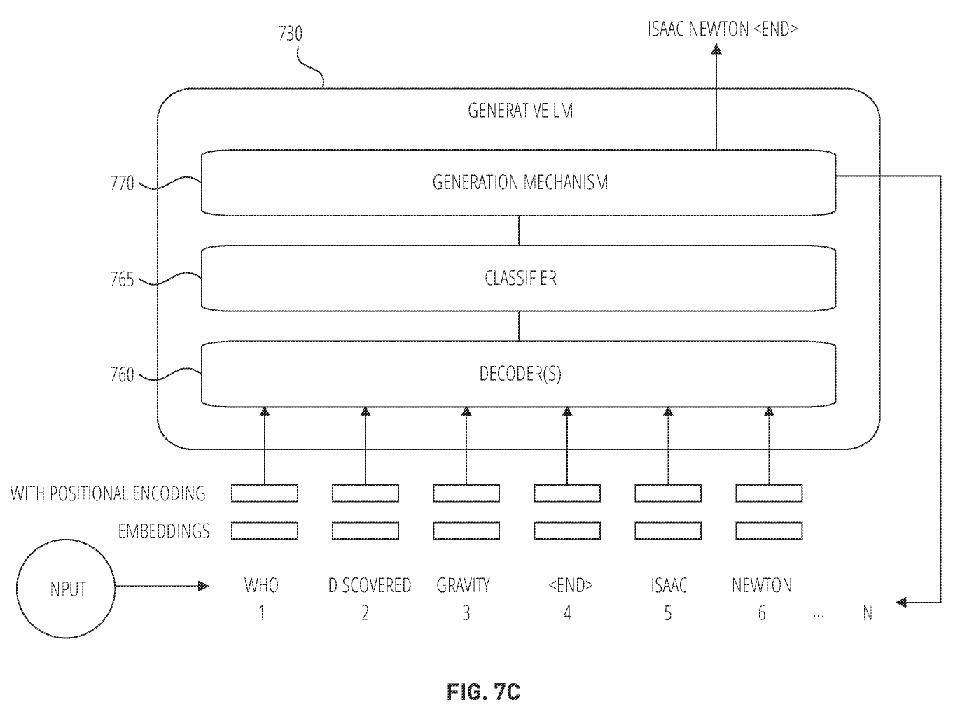

FIG. 7A is a block diagram of an example generative language model (LM) system, generative LM system 700, suitable for use in implementing at least some embodiments of the present disclosure. In the example illustrated in FIG. 7A, the generative LM system 700 includes a retrieval augmented generation (RAG) component 792, an input processor 705, a tokenizer 710, an embedding component 720, plug-ins/APIs 795, and a generative LM 730 (which may include an LLM, a VLM, a multi-modal LM, etc.).

At a high level, the input processor 705 may receive an input 701 comprising text and/or other types of input data (e.g., audio data, video data, image data, sensor data (e.g., LiDAR, RADAR, ultrasonic, etc.), 3D design data, CAD data, universal scene descriptor (USD) data – such as OpenUSD, etc.), depending on the architecture of the generative LM 730 (e.g., LLM/VLM/MMLM/etc.). In some embodiments, the input 701 includes plain text in the form of one or more sentences, paragraphs, and/or documents. Additionally or alternatively, the input 701 may include numerical sequences, precomputed embeddings (e.g., word or sentence embeddings), and/or structured data (e.g., in tabular formats, JSON, or XML). In some implementations in which the generative LM 730 is capable of processing multi-modal inputs, the input 701 may combine text (or may omit text) with image data, audio data, video data, design data, USD data, and/or other types of input data, such as but not limited to those described herein. Taking raw input text as an example, the input processor 705 may prepare raw input text in various ways. For example, the input processor 705 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 705 may remove stopwords to reduce noise and focus the generative LM 730 on more meaningful content. The input processor 705 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 792 (which may include one or more RAG models, and/or may be performed using the generative LM 730 itself) may be used to retrieve additional information to be used as part of the input 701 or prompt. RAG may be used to enhance the input to the LLM/VLM/MMLM/etc. with external knowledge, so that answers to specific questions or queries or requests are more relevant – such as in a case where specific knowledge is involved. The RAG component 792 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 701 may be generated using the query or input to the model (e.g., a question, a request, etc.) in addition to data retrieved using the RAG component 792. In some embodiments, the input processor 705 may analyze the input 701 and communicate with the RAG component 792 (or the RAG component 792 may be part of the input processor 705, in embodiments) in order to identify relevant text and/or other data to provide to the generative LM 730 as additional context or sources of information from which to identify the response, answer, or output 790, generally. For example, where the input indicates that the user is interested in a desired tire pressure for a particular make and model of vehicle, the RAG component 792 may retrieve – using a RAG model performing a vector search in an embedding space, for example – the tire pressure information or the text corresponding thereto from a digital (embedded) version of the user manual for that particular vehicle make and model. Similarly, where a user revisits a chatbot related to a particular product offering or service, the RAG component 792 may retrieve a prior stored conversation history – or at least a summary thereof – and include the prior conversation history along with the current ask/request as part of the input 701 to the generative LM 730.

The RAG component 792 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 792 and the embeddings of the chunks along with the embeddings of the query may be compared to identify the most similar/related embeddings to the query, which may be supplied to the generative LM 730 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents – which may result in a lack of context, factual correctness, language accuracy, etc. – graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 792 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in’s REST interface such that the graph database is decoupled from the vector database and/or the embeddings models.

The tokenizer 710 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 730 to understand morphological variations and handle out-of-vocabulary words more effectively. Character-based tokenization represents each character as a separate token, enabling the generative LM 730 to process text at a fine-grained level. The choice of tokenization strategy may depend on factors such as the language being processed, the task at hand, and/or characteristics of the training dataset. As such, the tokenizer 710 may convert the (e.g., processed) text into a structured format according to tokenization schema being implemented in the particular embodiment.

The embedding component 720 may use any known embedding technique to transform discrete tokens into (e.g., dense, continuous vector) representations of semantic meaning. For example, the embedding component 720 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 701 includes image data/video data/etc., the input processor 705 may resize the data to a standard size compatible with format of a corresponding input channel and/or may normalize pixel values to a common range (e.g., 0 to 1) to ensure a consistent representation, and the embedding component 720 may encode the image data using any known technique (e.g., using one or more convolutional neural networks (CNNs) to extract visual features). In some implementations in which the input 701 includes audio data, the input processor 705 may resample an audio file to a consistent sampling rate for uniform processing, and the embedding component 720 may use any known technique to extract and encode audio features – such as in the form of a spectrogram (e.g., a mel-spectrogram). In some implementations in which the input 701 includes video data, the input processor 705 may extract frames or apply resizing to extracted frames, and the embedding component 720 may extract features such as optical flow embeddings or video embeddings and/or may encode temporal information or sequences of frames. In some implementations in which the input 701 includes multi-modal data, the embedding component 720 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 730 and/or other components of the generative LM system 700 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 720 may apply an encoded representation of the input 701 to the generative LM 730, and the generative LM 730 may process the encoded representation of the input 701 to generate an output 790, which may include responsive text and/or other types of data.

As described herein, in some embodiments, the generative LM 730 may be configured to access or use – or capable of accessing or using – plug-ins/APIs 795 (which may include one or more plug-ins, application programming interfaces (APIs), databases, data stores, repositories, etc.). For example, for certain tasks or operations that the generative LM 730 is not ideally suited for, the model may have instructions (e.g., as a result of training, and/or based on instructions in a given prompt, such as those retrieved using the RAG component 792) to access one or more plug-ins/APIs 795 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 795 to the plug-in/API 795, the plug-in/API 795 may process the information and return an answer to the generative LM 730, and the generative LM 730 may use the response to generate the output 790. This process may be repeated – e.g., recursively – for any number of iterations and using any number of plug-ins/APIs 795 until an output 790 that addresses each ask/question/request/process/operation/etc. from the input 701 can be generated. As such, the model(s) may not only rely on its own knowledge from training on a large dataset(s) and/or from data retrieved using the RAG component 792, but also on the expertise or optimized nature of one or more external resources – such as the plug-ins/APIs 795.

FIG. 7B is a block diagram of an example implementation in which the generative LM 730 includes a transformer encoder-decoder. For example, assume input text such as “Who discovered gravity” is tokenized (e.g., by the tokenizer 710 of FIG. 7A) into tokens such as words, and each token is encoded (e.g., by the embedding component 720 of FIG. 7A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 735 of the generative LM 730.

In an example implementation, the encoder(s) 735 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 740 may convert the context vector into attention vectors (keys and values) for the decoder(s) 745.

In an example implementation, the decoder(s) 745 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 735, in an example transformer architecture, each token (e.g., word) flows through a separate path in the decoder(s) 745. During a first pass, the decoder(s) 745, a classifier 750, and a generation mechanism 755 may generate a first token, and the generation mechanism 755 may apply the generated token as an input during a second pass. The process may repeat in a loop, successively generating and adding tokens (e.g., words) to the output from the preceding pass and applying the token embeddings of the composite sequence with positional encodings as an input to the decoder(s) 745 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 735, except that it creates its queries from the layer below it and takes the keys and values (e.g., matrix) from the output of the encoder(s) 735.

As such, the decoder(s) 745 may output some decoded (e.g., vector) representation of the input being applied during a particular pass. The classifier 750 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 755 may select or sample a word or token based on a corresponding predicted probability (e.g., select the word with the highest predicted probability) and append it to the output from a previous pass, generating each word or token sequentially. The generation mechanism 755 may repeat the process, triggering successive decoder inputs and corresponding predictions until selecting or sampling a symbol or token that represents the end of the response, at which point, the generation mechanism 755 may output the generated response.

FIG. 7C is a block diagram of an example implementation in which the generative LM 730 includes a decoder-only transformer architecture. For example, the decoder(s) 760 of FIG. 7C may operate similarly as the decoder(s) 745 of FIG. 7B except each of the decoder(s) 760 of FIG. 7C omits the encoder-decoder self-attention layer (since there is no encoder in this implementation). As such, the decoder(s) 760 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 760. As with the decoder(s) 745 of FIG. 7B, each token (e.g., word) may flow through a separate path in the decoder(s) 760, and the decoder(s) 760, a classifier 765, and a generation mechanism 770 may use auto-regression to sequentially generate one token at a time until predicting a symbol or token that represents the end of the response. The classifier 765 and the generation mechanism 770 may operate similarly as the classifier 750 and the generation mechanism 755 of FIG. 7B, with the generation mechanism 770 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### EXAMPLE MACHINE LEARNING SYSTEM

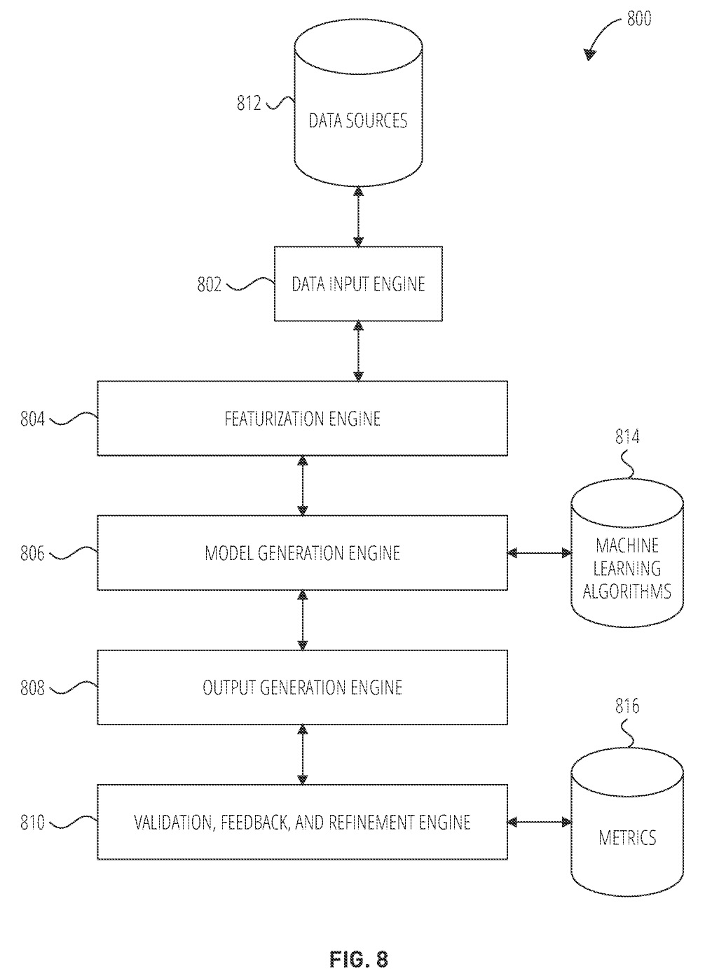

FIG. 8 illustrates a machine learning system 800, according to some embodiments. The machine learning system 800 may be used to implement aspects of the present disclosure. The machine learning system 800 is shown to include a data input engine 802, a featurization engine 804, a model generation engine 806, an output generation engine 808, and a validation, feedback, and refinement engine 810.

The data input engine 802 may be configured to access, interpret, request, format, re-format, or receive input data from data sources 812. Data sources 812 may include training data (e.g., data for training machine learning models), validation data (e.g., data for comparing model output with known results to evaluate performance), or reference data (e.g., data used to establish baselines or inform model creation). The data input engine 802 can interact with external data systems via input/output (I/O) devices, network interfaces, or storage elements to ensure input data is processed and stored in a suitable format for further operations.

The featurization engine 804 may be configured to transform input data into features that are optimized or useful for machine learning. The featurization engine 804 can handle feature extraction, scaling, or selection, enabling the machine learning system 800 to identify and process relevant data attributes for subsequent modeling. For example, features extracted from raw data may be annotated, labeled, or transformed into numerical representations suitable for machine learning algorithms 814. The featurization engine 804 can work iteratively with other components to refine features based on model requirements or outcomes.

The model generation engine 806 is responsible for creating, training, and configuring one or more machine learning models based on input data and selected features. The model generation engine 806 may include functionality for model selection, hyperparameter tuning, or algorithm implementation.

Machine learning broadly involves using computer algorithms to automatically learn patterns and/or relationships in data, often without the need for explicit programming. Thus, the machine learning algorithms 814 may include various algorithms, including supervised, unsupervised, or reinforcement learning approaches, such as decision trees, neural networks, Support Vector Machines (SVMs), or deep learning architectures such as transformers or Convolutional Neural Networks (CNNs). The model generation engine 806 may also support iterative model refinement and validation cycles, enabling adaptability to evolving data or performance criteria.

In some embodiments, the output generation engine 808 is responsible for model inference. The output generation engine 808 processes data to produce predictions, classifications, or other results. The output generation engine 808 can also apply post-processing techniques such as aggregation, thresholding, or confidence scoring to ensure outputs are in a format suitable for downstream systems or user interpretation.

The validation, feedback, and refinement engine 810 may be configured to validate, monitor, or improve the performance and relevance of machine learning models over time. The validation, feedback, and refinement engine 810 can apply validation data to assess model outputs and integrate feedback from users or automated systems to improve models. Metrics 816 may be used to evaluate and compare model outputs against validation data or other useful data, providing insights into model performance, accuracy, reliability, or generalization. Refinement operations may involve retraining models with updated data or adjusting model parameters to account for changing conditions or newly observed patterns.

Components of the machine learning system 800 may be implemented by hardware processors and may communicate via network interfaces or shared storage elements to facilitate data exchange and coordination. The architecture shown in FIG. 8 allows for flexible deployment across various machine learning applications, such as natural language processing, computer vision, or predictive analytics.

In some embodiments, the machine learning system 800 may be configured to implement the ML surrogate model 106 described in the present disclosure. The data input engine 802 may process the input data 102, which may include complex geometric shapes such as tessellated STL files containing vertices, edges, and triangular faces that define vehicle designs for aerodynamic simulations, mechanical structures for stress analysis, or electromagnetic components. The featurization engine 804 may transform these geometric inputs into point cloud representations and compute shape-based distance metrics by performing nearest-neighbor mapping between points and calculating average distances between mapped points, enabling the pre-model validation 108 functionality.

In some embodiments, the model generation engine 806 may implement various surrogate modeling techniques specifically designed for scientific machine learning applications, such as polynomial regression, Gaussian process models (Kriging), or neural network architectures that can rapidly approximate computationally intensive engineering simulations. Unlike general machine learning models, these surrogate models are trained on simulation data to reduce processing time while maintaining accuracy for design optimization tasks. The output generation engine 808 may perform the model processing 112 function, generating predictions that approximate the results of high-fidelity simulations.

The validation, feedback, and refinement engine 810 may implement the post-model validation 110 functionality by computing normalized partial differential equation (PDE) residuals that quantify adherence to physical laws such as mass conservation, momentum conservation, or geometric symmetry properties. When validation fails, this component may route the input to the simulation service 114, which generates simulation results that can be used for fine-tuning 118 the surrogate model through a prediction-correction scheme that maintains the base model while training a separate correction model. This integrated approach enables the machine learning system 800 to provide both computational efficiency and physical consistency in scientific simulation applications.

### EXAMPLE MACHINE LEARNING PIPELINE

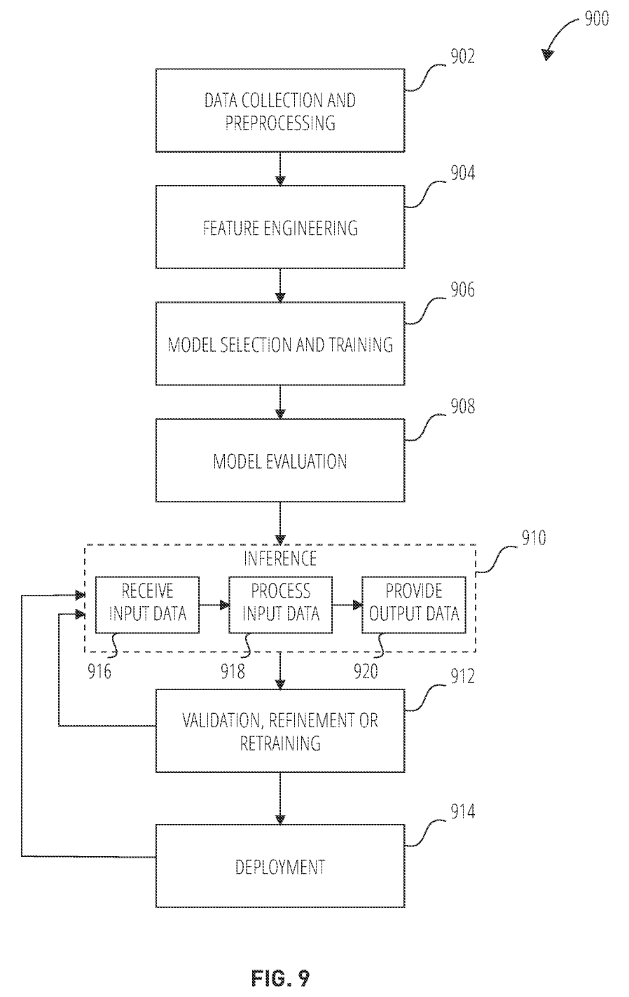

FIG. 9 is a flowchart depicting a machine learning pipeline 900, according to some embodiments. The machine learning pipeline 900, or parts thereof, may be used to generate a trained machine learning model for use in embodiments of the present disclosure.

The machine learning pipeline 900 commences with a data collection and preprocessing stage 902, in which data is acquired, cleaned, or formatted for compatibility with machine learning algorithms. The data collection and preprocessing stage 902 may also involve addressing issues such as duplicate entries, missing values, or data inconsistencies.

During a feature engineering stage 904, training data can be formatted, transformed, or selected as needed to create features that are useful for predicting target data. Feature engineering may include (1) receiving features (e.g., as structured or labeled data in supervised learning) and/or (2) identifying features (e.g., unstructured or unlabeled data for unsupervised learning) in training data. In this context, a feature may be a variable or attribute, such as a measurable property of a process, article, system, or phenomenon represented by a data set. Features may also be of different types, such as numeric features, strings, and graphs, and may include one or more of content, concepts, attributes, historical data, or user data, merely for example.

A model selection and training stage 906 can include selecting an appropriate machine learning algorithm or strategy and training the relevant model on training data. The model selection and training stage 906 may involve splitting the data into training and testing sets, using cross-validation to evaluate the model, and tuning hyperparameters to improve performance. During training, the model may be trained to find features that affect a predicted outcome. The result of the training is a trained machine learning model.

In some embodiments, techniques such as model quantization, pruning, or knowledge distillation can reduce the computational complexity of a trained model. Quantization involves reducing the precision of weights and activations (e.g., from 32-bit floating-point to 8-bit integers), enabling efficient deployment on hardware-constrained environments such as edge devices. Pruning removes redundant or non-contributory connections within a model, thereby reducing memory and processing requirements. Knowledge distillation transfers the learned knowledge of a large, complex model into a smaller, lightweight model.

A model evaluation stage 908 may include evaluating the performance of a trained model on a separate testing dataset. This can help determine if the model is overfitting or underfitting and determine whether the model is suitable for deployment. Regularization techniques, such as dropout or L2 regularization, may also be employed to prevent overfitting and improve generalization.

FIG. 9 further shows an inference stage 910, in which a trained model generates outputs on new, unseen data. For example, for each input, at operation 916, the model receives input data (e.g., from external sources, such as real-time sensors, databases, or user-provided queries, or internal sources such as test inputs). At operation 918, the trained model processes the input data. This can include various operations that are performed to arrive at output data, such as feature extraction, transformation, and embedding generation, depending on the model architecture. For example, a CNN may process input images by applying convolutional filters, while a transformer model might encode textual input using self-attention mechanisms. The trained model may perform inference, mapping inputs to outputs, such as predictions or classifications, thereby providing the output data at operation 920.

It is noted that output data may take various forms. In classification AI examples, outputs may include data classifications or probabilities linked to particular classifications. In generative AI examples, outputs may include new content, such as translations, summaries, answers, new media content, or combinations thereof. In some embodiments, outputs are further processed into usable output, such as probabilities, labels, or continuous values tailored for downstream systems. Post-processing may include confidence scoring, aggregation, or error correction, to ensure outputs are accurate and actionable for the intended application.

The machine learning pipeline 900 may also include a validation, refinement, or retraining stage 912. This may include updating a model based on feedback generated from the inference stage 910, such as new data or user feedback. In some embodiments, validation is performed using a separate dataset known as the validation dataset. The validation dataset can be used to tune or fine-tune the hyperparameters of a model, such as the learning rate and the regularization parameter. The hyperparameters may be adjusted to improve the model’s performance on the validation dataset.

During deployment stage 914, the trained model is integrated into or connected with a more extensive or real-world system, application, or environment, such as a web service, mobile app, or Internet of Things (IoT) device. This phase can involve setting up APIs, building a user interface, and ensuring that the model is scalable and can handle large volumes of data. In some embodiments, the trained model is deployed on a single device, such as locally on an end user’s computing device or on an edge device, as opposed to being deployed on a server system. This may provide lower latency or offline functionality in certain scenarios. Accordingly, various trained models can be deployed as server-based deployments or on-device deployments.

In some embodiments, a trained model includes one or more neural networks. The neural network may include a hierarchical (e.g., layered) organization of neurons or nodes, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron may operationally compute a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

A neural network can be applied in various scenarios. In some cases, the neural network is configured to perform an image or video processing task. For example, the task may be image classification. As another example, the task can be image embedding generation and the output generated by the neural network can be a numeric embedding of the input image. As yet another example, the task can be object detection and the output generated by the neural network can identify locations in the input image at which particular types of objects are depicted. As another example, if the input to the neural network is a sequence of text in one language, the output generated by the neural network may be a piece of text in the other language that is a predicted proper translation of the input text into the other language.

In some cases, a machine learning task is a multi-modal processing task that requires processing multi-modal data. In general, multi-modal data is a combination of two or more different types of data, e.g., two or more of audio data, image data, text data, or graph data. As one example, the multi-modal data may comprise audio-visual data, comprising a combination of pixels of an image or of video and audio data representing values of a digitized audio waveform. As another example, the multi-modal data may comprise a combination of text data representing text in a natural language and pixels of an image.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

In some embodiments, the neural network may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a CNN, a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

As mentioned, a generative AI model can generate new content. For example, generative AI can produce text, images, video, audio, code, or synthetic data. In some embodiments, the generated content may be similar to original data, but not identical.

Some of the techniques or architectures that may be used in generative AI are GANs, Variational autoencoders (VAEs), and transformers. GANs may include two neural networks:
a generator and a discriminator. The generator network attempts to create realistic content that can “fool” the discriminator network, while the discriminator network attempts to distinguish between real and fake content. The generator and discriminator networks compete with each other and improve over time. VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models may use attention mechanisms to learn the relationships between different parts of input data (such as words or pixels) and generate output data based on these relationships. In some embodiments, transformer models can handle sequential data, such as text or speech, as well as non-sequential data, such as images or code.

### Example machine learning model specification, training, and configuration

In some embodiments, the machine learning model is in the form of a surrogate model for scientific machine learning applications. The architecture of this machine learning model includes, for example, neural networks, Gaussian process models, or polynomial regression models designed to approximate complex physics-based simulations. For instance, a neural network may include multiple hidden layers with ReLU activation functions and fully connected layers for processing geometric input data.

The example machine learning model is trained using supervised learning. The training process may employ gradient descent optimization techniques, with a focus on minimizing a loss function such as mean squared error between the surrogate model predictions and high-fidelity simulation results. The model parameters are adjusted iteratively based on batch training with adaptive learning rate schedules to ensure convergence.

In some embodiments, the training data used for the machine learning model is sourced from high-fidelity simulations such as computational fluid dynamics, computational mechanics, or electromagnetics simulations. The training data may include representative variations of the relevant parameters, such as inlet velocities, geometric shapes, and operating conditions. For instance, the training dataset is structured to cover a range of velocities from 20m/s to 80m/s and includes approximately a few hundred simulation examples.

Input data to the machine learning model may include three-dimensional geometric shapes such as tessellated STL files containing nodes and edges, inlet velocities, temperatures, and other operating parameters. In some examples, these inputs undergo preprocessing before being used for training or inference. Geometric inputs are converted to point cloud representations through a process that transforms tessellated geometries into collections of spatial coordinates, where each node becomes a point in three-dimensional space. These point clouds then undergo nearest-neighbor mapping and normalization techniques to enable shape-based distance calculations and consistent comparison with training examples. For example, the system places geometries at the same origin before performing mapping operations to establish a consistent reference frame for comparing different shapes.

The output of the machine learning model represents predicted simulation results such as flow fields, stress distributions, or electromagnetic field distributions. In some embodiments, the machine learning model generates outputs such as pressure distributions or aerodynamic coefficients in a format compatible with downstream processes, using scaling and normalization to ensure physical consistency.

The example machine learning model uses specific parameters for its computations, including learning rates, regularization coefficients, and shape-based distance thresholds. These parameters can be chosen based on empirical analysis and domain-specific knowledge of the physical systems being simulated. For example, the threshold for shape-based distance metrics is set based on the distribution of distances observed in the training data. To ensure the effectiveness of the machine learning model, input parameters are selected based on their relevance to the predicted output. For instance, geometric shape characteristics and inlet conditions have been identified as parameters influencing aerodynamic simulation predictions. Parameters that are less relevant may be omitted or weighted lower during training.

In some embodiments, training data undergoes validation to ensure quality and representativeness. This can include checks for geometric consistency, physical plausibility, and outlier detection. For example, outlier detection is performed using shape-based distance metrics, and invalid data points are either corrected or excluded from the training process.

The machine learning model may be adapted periodically using new data from the simulation service when validation guardrails detect out-of-distribution inputs or physically implausible outputs. Adaptation may involve fine-tuning using a prediction-correction scheme that maintains the base model while training a separate correction model to account for new simulation results from previously unseen geometric inputs.

The machine learning model can be deployed in various environments, including cloud-based inference platforms. Deployment considerations include optimizing for inference speed and accuracy, ensuring compatibility with GPU-optimized model serving capabilities, and adhering to physical law consistency requirements. For instance, the model may be containerized for deployment on a cloud-native inference platform that processes validated input using GPU-optimized capabilities. In some embodiments, deployment involves leveraging accelerators such as GPUs to enhance inference speed. Additionally, monitoring tools may be used to track the model's physical law adherence through normalized PDE residuals to ensure reliability in production.

In some embodiments, the machine learning pipeline 900 may be configured to implement the ML surrogate model 106 described in the present disclosure. During the data collection and preprocessing stage 902, the system may process training data comprising geometric shapes such as tessellated STL files containing vertices, edges, and triangular faces that define vehicle designs, mechanical structures, or electromagnetic components. This stage may also generate shape-based distance metrics by converting geometric shapes to point cloud representations, performing nearest-neighbor mapping between points, and computing average distances between mapped points.

The feature engineering stage 904 may implement the pre-model validation 108 functionality by extracting shape-based characteristics from input geometric data and comparing them against the shape-based distance metrics derived from training data to determine if inputs fall within a predetermined distribution range. This validation serves as the first guardrail in the dual guardrail framework, detecting out-of-distribution inputs before they reach the model.

The model selection and training stage 906 may implement various surrogate modeling techniques specifically designed for scientific machine learning applications, such as polynomial regression, Gaussian process models, or neural networks that can rapidly approximate computationally intensive engineering simulations like computational fluid dynamics, computational mechanics, or electromagnetics. These surrogate models are trained to reduce processing time from hours to seconds while maintaining acceptable accuracy for design optimization tasks.

During the inference stage 910, the trained model processes validated input data, generating predictions that approximate the results of high-fidelity simulations. Following inference, the validation, refinement, or retraining stage 912 may implement the post-model validation 110 functionality by computing normalized partial differential equation (PDE) residuals that quantify adherence to physical laws such as mass conservation, momentum conservation, or geometric symmetry properties. This serves as the second guardrail in the framework.

When validation fails at either guardrail, the system may route the input to a simulation service 114, which performs high-fidelity simulations and generates results that can be used during the refinement stage 912 to fine-tune the surrogate model through a prediction-correction scheme. This integrated approach enables the machine learning pipeline 900 to provide both computational efficiency and physical consistency in scientific simulation applications.

### EXAMPLE COMPUTING DEVICE

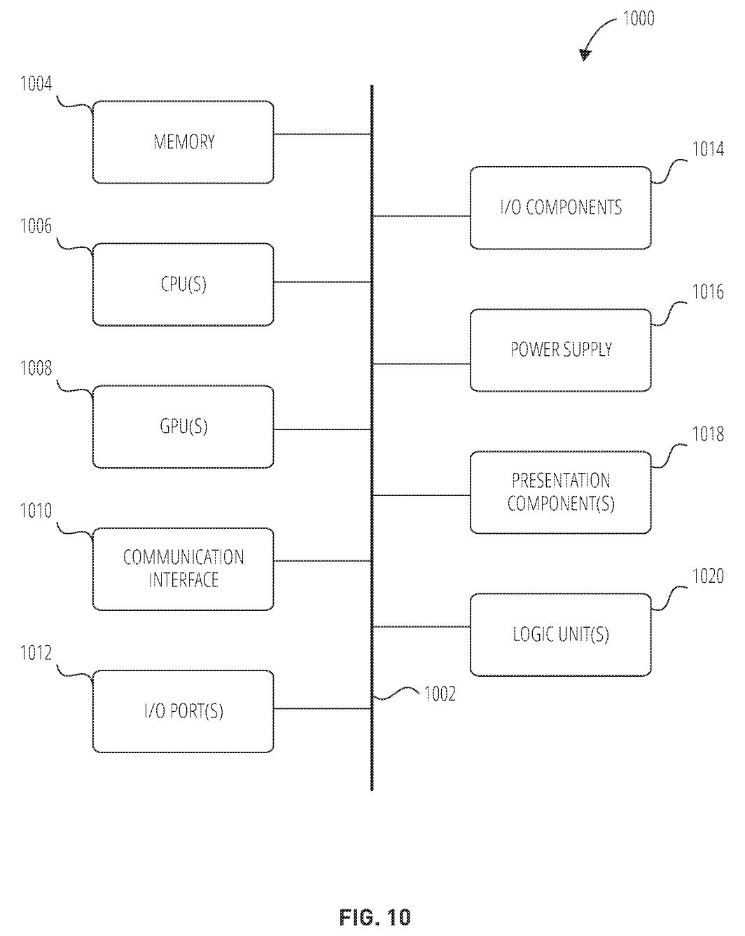

FIG. 10 is a block diagram of an example computing device 1000 suitable for use in implementing some embodiments of the present disclosure. Computing device 1000 may include an interconnect system 1002 that directly or indirectly couples the following devices:
memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device 1000 may comprise one or more virtual machines (VMs), and/or any of the components thereof may comprise virtual components (e.g., virtual hardware components). For non-limiting examples, one or more of the GPU(s) 1008 may comprise one or more vGPUs, one or more of the CPU(s) 1006 may comprise one or more vCPUs, and/or one or more of the logic unit(s) 1020 may comprise one or more virtual logic units. As such, a computing device 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPU(s) 1008, the CPU(s) 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or buses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU(s) 1006 may be directly connected to the memory 1004. Further, the CPU(s) 1006 may be directly connected to the GPU(s) 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPU(s) 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic unit(s) 1020 may be part of and/or integrated in one or more of the CPU(s) 1006 and/or the GPU(s) 1008 and/or one or more of the logic unit(s) 1020 may be discrete components or otherwise external to the CPU(s) 1006 and/or the GPU(s) 1008. In embodiments, one or more of the logic unit(s) 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs) – which may include one or more direct memory access (DMA) systems, one or more vision or vector processing units (VPUs), one or more pixel processing engines (PPEs) – e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O port(s) 1012 may allow the computing device 1000 to be logically coupled to other devices including the I/O components 1014, the presentation component(s) 1018, and/or other components, some of which may be built in to (e.g., integrated in) the computing device computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some embodiments, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### EXAMPLE DATA CENTER

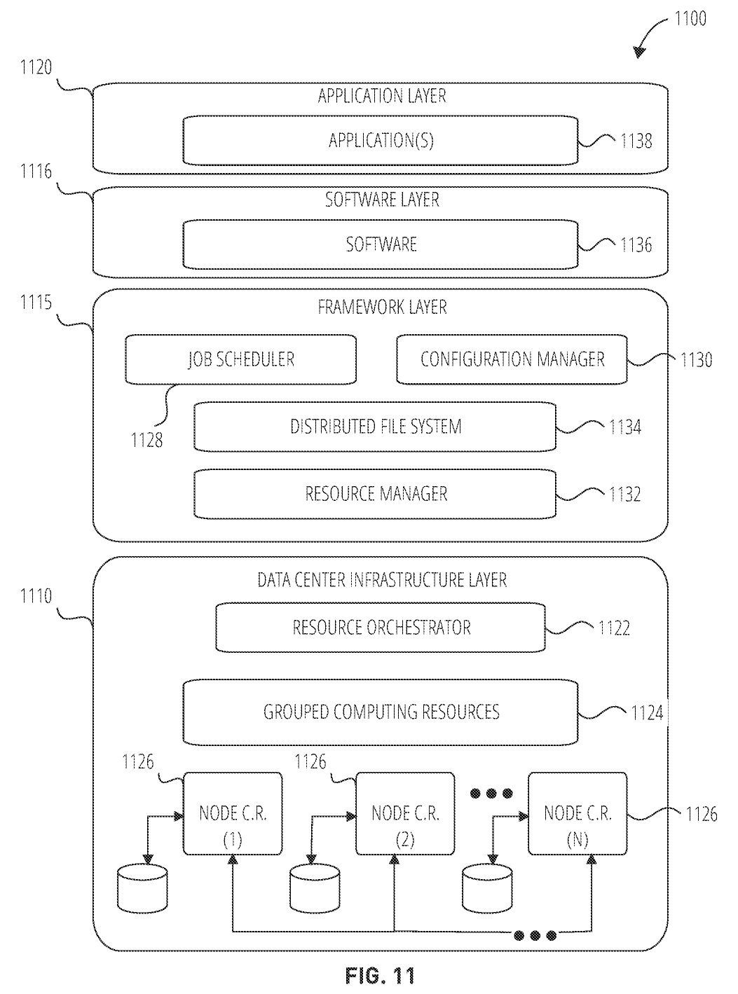

FIG. 11 illustrates an example data center 1100 that may be used in at least one embodiment of the present disclosure. The data center 1100 may include a data center infrastructure layer 1110, a framework layer 1115, a software layer 1116, and/or an application layer 1120.

As shown in FIG. 11, the data center infrastructure layer 1110 may include a resource orchestrator 1122, grouped computing resources 1124, and node computing resources 1126 (“node C.R.s”), shown as (1)-(N), where “N” represents any whole, positive integer. In at least one embodiment, node computing resources 1126 may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more nodes from among node computing resources 1126 may correspond to a server having one or more of the above-mentioned computing resources. In addition, in some embodiments, the node computing resources 1126 may include one or more virtual components, such as vGPUs, vCPUs, and/or the like, and/or one or more of the node computing resources 1126 may correspond to a virtual machine (VM).

In at least one embodiment, grouped computing resources 1124 may include separate groupings of node computing resources 1126 housed within one or more racks (not shown), or many racks housed in data centers at various geographical locations (also not shown). Separate groupings of node computing resources 1126 within grouped computing resources 1124 may include grouped compute, network, memory or storage resources that may be configured or allocated to support one or more workloads. In at least one embodiment, several node computing resources 1126 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1122 may configure or otherwise control one or more node computing resources 1126 and/or grouped computing resources 1124. In at least one embodiment, resource orchestrator 1122 may include a software design infrastructure (SDI) management entity for the data center 1100. The resource orchestrator 1122 may include hardware, software, or some combination thereof.

In at least one embodiment, as shown in FIG. 11, framework layer 1115 may include a job scheduler 1128, a configuration manager 1130, a resource manager 1132, and/or a distributed file system 1134. The framework layer 1115 may include a framework to support software 1136 of software layer 1116 and/or one or more application(s) 1138 of application layer 1120. The software 1136 or application(s) 1138 may respectively include web-based service software or applications, such as those provided by Amazon Web Services, Google Cloud and Microsoft Azure. The framework layer 1115 may be, but is not limited to, a type of free and open-source software web application framework such as Apache Spark^{TM} (hereinafter “Spark”) that may use distributed file system 1134 for large-scale data processing (e.g., "big data"). In at least one embodiment, job scheduler 1128 may include a Spark driver to facilitate scheduling of workloads supported by various layers of data center 1100. The configuration manager 1130 may be capable of configuring different layers such as software layer 1116 and framework layer 1115 including Spark and distributed file system 1134 for supporting large-scale data processing. The resource manager 1132 may be capable of managing clustered or grouped computing resources mapped to or allocated for support of distributed file system 1134 and job scheduler 1128. In at least one embodiment, clustered or grouped computing resources may include grouped computing resources 1124 at data center infrastructure layer 1110. The resource manager 1132 may coordinate with resource orchestrator 1122 to manage these mapped or allocated computing resources.

In at least one embodiment, software 1136 included in software layer 1116 may include software used by at least portions of node computing resources 1126, grouped computing resources 1124, and/or distributed file system 1134 of framework layer 1115. One or more types of software may include, but are not limited to, Internet web page search software, e-mail virus scan software, database software, and streaming video content software.

In at least one embodiment, application(s) 1138 included in application layer 1120 may include one or more types of applications used by at least portions of node computing resources 1126, grouped computing resources 1124, and/or distributed file system 1134 of framework layer 1115. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1130, resource manager 1132, and resource orchestrator 1122 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using the above-described resources. Moreover, one or more software and/or hardware resources described above may be configured as a service to allow users to train or perform inferencing of information, such as image recognition, speech recognition, or other artificial intelligence services.

### EXAMPLE USE CASES

In some embodiments, the technology may be implemented to validate machine learning models that predict aerodynamic performance of vehicle designs. The framework 100 may process tessellated STL files containing vertices, edges, and triangular faces that define vehicle geometries.

In at least some embodiments, the framework 100 shown in FIG. 1 may receive CAD models of vehicle designs as input data 102. The pre-model validation 108 may convert these geometric inputs into point cloud representations and perform nearest-neighbor mapping between points to compute average distances, as illustrated in FIG. 3 blocks 306-310. When a new vehicle design is submitted, the shape descriptor approach shown in FIG. 4 may determine if the design falls within the distribution range of training data (e.g., comparing a new sedan design against training data of various sedans).

In some embodiments, if the design passes pre-model validation, the ML surrogate model 106 may predict aerodynamic coefficients such as drag and lift. The post-model validation 110 shown in FIG. 5 may then verify these predictions by computing normalized PDE residuals from the Navier-Stokes equations. The system may check symmetry properties of the predicted flow field when the vehicle geometry exhibits symmetry, as shown in block 506 of FIG. 5.

In at least some embodiments, the technology may be applied to thermal management in semiconductor design, where ML surrogate models can accelerate cooling system simulations that would otherwise require computationally intensive CFD analysis.

As shown in FIG. 2, the training data processing layer 202 may process geometric data of various cooling system designs. The shape descriptors 210 may convert these designs into point cloud representations for comparison. When a new cooling system design is submitted, the pre-model validation layer 204 may determine if the design's geometric characteristics fall within the distribution of training data.

In some embodiments, the ML surrogate model 106 may then predict temperature distributions and cooling efficiency. The post-model validation layer 206 may verify these predictions using the multi-level validator 224, which may check adherence to heat transfer equations. The physical law checker 226 may verify that predicted temperatures remain physically plausible (e.g., above absolute zero). If validation fails, the simulation service 114 shown in FIG. 6 may perform high-fidelity thermal simulations to generate more accurate results.

In at least some embodiments, the technology may validate ML models that predict stress distributions and deformations in complex structures, reducing the need for computationally expensive finite element analysis.

The framework in FIG. 1 may receive CAD models of structural components as input data 102. The pre-model validation 108 may convert these models into point cloud representations and compare them against training data using the process outlined in FIG. 3. For complex structures with multiple components, the neural encoders 218 shown in FIG. 2 may generate lower-dimensional latent space representations to facilitate comparison.

In some embodiments, the ML surrogate model 106 may predict stress distributions and deformation patterns. The post-model validation 110 may verify these predictions by computing normalized PDE residuals from structural mechanics equations. The first-order PDE calculator 228 may verify force equilibrium, while the second-order PDE calculator 230 may verify more complex mechanical relationships. If validation fails, the simulation service 114 may perform detailed finite element analysis.

In some embodiments, the technology may validate ML models that predict electromagnetic field distributions in antennas, waveguides, or other electromagnetic components, accelerating the design optimization process.

As illustrated in FIG. 2, the framework 100 may process tessellated geometries of electromagnetic components through the pre-model validation layer 204. The point cloud converter 212 may transform these geometries into point cloud representations, and the nearest neighbor mapper 214 may establish correspondence between points of different designs.

In at least some embodiments, the ML surrogate model 106 may predict electromagnetic field distributions. The post-model validation layer 206 may verify these predictions using Maxwell's equations. The physical law checker 226 may verify symmetry properties when the electromagnetic structure exhibits symmetry. The ensemble uncertainty component 236 may provide statistical confidence measures for the predictions.

In some embodiments, the technology may validate ML models that predict aerodynamic performance of wing designs, enabling rapid iteration and optimization.

The framework 100 shown in FIG. 1 may receive CAD models of wing designs as input data 102. The pre-model validation 108 may convert these models into point cloud representations and compare them against training data using the process outlined in FIG. 3. For wings with complex geometries, the system may implement both the point cloud method and neural encoder method shown in FIG. 4 blocks 410 and 412.

In at least some embodiments, the ML surrogate model 106 may predict pressure distributions and aerodynamic forces. The post-model validation 110 may verify these predictions by computing normalized PDE residuals from the Navier-Stokes equations. The system may implement the multi-level validation process shown in FIG. 5, starting with lightweight physical checks and progressing to more computationally intensive validations.

In some embodiments, the technology may validate ML models that predict blood flow patterns in medical devices such as stents, heart valves, or artificial vessels, reducing the need for time-consuming CFD simulations.

The system may process geometric data of various medical device designs through the training data processing layer 202 shown in FIG. 2. When a new design is submitted, the pre-model validation layer 204 may determine if the design's geometric characteristics fall within the distribution of training data.

In at least some embodiments, the ML surrogate model 106 may predict blood flow patterns and pressure distributions. The post-model validation layer 206 may verify these predictions using the multi-level validator 224, which may check adherence to fluid dynamics equations. The physical law checker 226 may verify that predicted flow patterns maintain conservation of mass. If validation fails, the simulation service 114 may perform high-fidelity CFD simulations.

In some embodiments, the technology may validate ML models that predict thermal and electrochemical behavior in battery designs, accelerating the development of more efficient energy storage solutions.

The framework 100 in FIG. 1 may receive geometric data of battery components as input data 102. The pre-model validation 108 may convert these geometries into point cloud representations and compare them against training data. For complex battery architectures, the neural encoders 218 shown in FIG. 2 may generate lower-dimensional latent space representations.

In at least some embodiments, the ML surrogate model 106 may predict temperature distributions and electrochemical performance. The post-model validation 110 may verify these predictions by computing normalized PDE residuals from heat transfer and electrochemical equations. The system may implement the multi-level validation process shown in FIG. 5, with increasing computational complexity for more thorough validation.

In some embodiments, the technology may validate ML models that predict energy performance of building designs, considering factors such as thermal insulation, solar gain, and natural ventilation.

The framework 100 may process geometric data of building designs through the training data processing layer 202 shown in FIG. 2. The shape descriptors 210 may convert these designs into point cloud representations for comparison. When a new building design is submitted, the pre-model validation layer 204 may determine if the design's geometric characteristics fall within the distribution of training data.

In at least some embodiments, the ML surrogate model 106 may predict energy consumption patterns and thermal comfort metrics. The post-model validation layer 206 may verify these predictions using the multi-level validator 224, which may check adherence to heat transfer and fluid dynamics equations. If validation fails, the simulation service 114 may perform detailed energy simulations.

### EXAMPLE SET 1

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is one or more processors comprising processing circuitry to:
process training data comprising geometric shapes to generate shape-based distance metrics;
validate input geometric data for a machine learning model by comparing shape-based characteristics of the input geometric data against the shape-based distance metrics to determine that the input geometric data falls within a predetermined distribution range of the training data; and
selectively process the input geometric data using the machine learning model, based on the input geometric data falling within the predetermined distribution range of the training data.

In Example 2, the subject matter of Example 1, wherein the processing circuitry is further to process output data from the machine learning model by computing normalized partial differential equation (PDE) residuals that quantify adherence to physical laws.

In Example 3, the subject matter of Example 2, wherein the processing circuitry is further to implement a dual guardrail framework comprising:
a pre-model validation using the shape-based distance metrics to detect out-of-distribution inputs; and a post-model validation using the normalized PDE residuals to quantify the adherence to at least one physical law.

In Example 4, the subject matter of any one or more of Examples 1-3, wherein the processing circuitry is further, failing at least one of the pre-model validation or the post-model validation, to:
route the input geometric data to a simulation service;
generate, by the simulation service, simulation results; and
using the simulation results generated by the simulation service, to fine-tune the machine learning model.

In Example 5, the subject matter of Example 4, wherein fine-tuning the machine learning model comprises implementing a prediction-correction scheme that maintains the machine learning model while training a separate correction model.

In Example 6, the subject matter of any one or more of Examples 1-3, wherein processing the training data to generate the shape-based distance metrics comprises:
converting the geometric shapes into point cloud representations comprising points;
performing nearest-neighbor mapping between the points; and computing average distances between mapped points.

In Example 7, the subject matter of any one or more of Examples 1-3, wherein the post-model validation comprises:
performing a first validation using computationally lightweight physical checks;
performing a second validation using first-order PDE derivatives based on the first validation passing; and
performing a third validation using second-order PDE derivatives based on the second validation passing.

In Example 8, the subject matter of any one or more of Examples 1-7, wherein comparing shape-based characteristics comprises:
converting the input geometric data into a lower-dimensional latent space representation using a neural encoder; and
comparing the latent space representation against encoded representations of the training data.

In Example 9, the subject matter of Example 8, wherein the neural encoder comprises an autoencoder neural network that compresses high-dimensional geometric data into the lower-dimensional latent space representation.

In Example 10, the subject matter of any one or more of Examples 1-9, wherein the machine learning model comprises a surrogate model for at least one of computational fluid dynamics, computational mechanics, or electromagnetics simulations.

In Example 11, the subject matter of any one or more of Examples 1-10, wherein the predetermined distribution range is configurable based on user-specified accuracy requirements.

In Example 12, the subject matter of any one or more of Examples 1-11, wherein the geometric shapes comprise computer-aided design (CAD) models.

In Example 13, the subject matter of any one or more of Examples 1-12, wherein the processing circuitry is further to implement a correction model separate from the machine learning model and use the correction model to adjust outputs of the machine learning model.

In Example 14, the subject matter of any one or more of Examples 1-13, wherein the processing circuitry is further to log validation results and provide validation notifications to a user.

In Example 15, the subject matter of any one or more of Examples 1-14, wherein the processing circuitry is further to implement an ensemble uncertainty analysis to provide statistical confidence measures for predictions generated by the machine learning model.

In Example 16, a method performed by a computing system comprising one or more processors, the method comprising:
receiving geometric input data for processing by a machine learning model;
comparing shape-based characteristics of the geometric input data to shape-based distance metrics derived from training data;
determining that the geometric input data falls within a predetermined distribution range of the training data based on the comparing of the shape-based characteristics of the geometric input data to the shape-based distance metrics derived from the training data; and
selectively processing the geometric input data using the machine learning model based on the determination that the geometric input data falls within the predetermined distribution range of the training data.

In Example 17, the subject matter of Example 16, further comprising:
computing normalized partial differential equation (PDE) residuals from output data of the machine learning model; and
verifying adherence of the output data to physical laws based on the normalized PDE residuals.

In Example 18, the subject matter of any one or more of Examples 16-17, further comprising:
determining that the geometric input data falls outside the predetermined distribution range; and
based on the determination that the geometric input data falls outside the predetermined distribution range of the training data:
   causing the geometric input data to be processed by a simulation service;
   accessing simulation results generated by the simulation service; and
   fine-tuning the machine learning model using the simulation results.

In Example 19, the subject matter of any one or more of Examples 16-18, wherein comparing shape-based characteristics comprises:
converting the geometric input data into a point cloud representation comprising points;
performing nearest-neighbor mapping between points; and
computing average distances between mapped points.

In Example 20, the subject matter of Example 17, wherein verifying adherence comprises:
performing an initial validation using computationally lightweight physical checks;
performing a subsequent validation using first-order PDE derivatives responsive to the initial validation passing; and
performing a final validation using second-order PDE derivatives responsive to the subsequent validation passing.

### EXAMPLE SET 2

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is one or more processors comprising processing circuitry to:
process training data comprising geometric shapes to generate shape-based distance metrics;
implement a pre-model validation guardrail to validate input geometric data for a machine learning model by comparing shape-based characteristics of the input geometric data against the shape-based distance metrics to determine whether the input geometric data falls within a predetermined distribution range of the training data;
implement a post-model validation guardrail to validate output data from the machine learning model by computing normalized partial differential equation (PDE) residuals that quantify adherence to physical laws; and
selectively process the input geometric data using the machine learning model based on validation results from the pre-model validation guardrail and the post-model validation guardrail.

In Example 2, the subject matter of Example 1, wherein the processing circuitry is further to, upon failure of at least one of the pre-model validation guardrail or the post-model validation guardrail:
route the input geometric data to a simulation service;
generate, by the simulation service, simulation results; and
use the simulation results generated by the simulation service to fine-tune the machine learning model.

In Example 3, the subject matter of any one or more of Examples 1-2, wherein processing the training data to generate the shape-based distance metrics comprises:
converting the geometric shapes into point cloud representations comprising points;
performing nearest-neighbor mapping between the points; and
computing average distances between mapped points.

In Example 4, the subject matter of any one or more of Examples 1-3, wherein comparing shape-based characteristics comprises:
converting the input geometric data into a lower-dimensional latent space representation using a neural encoder; and
comparing the latent space representation against encoded representations of the training data.

In Example 5, the subject matter of any one or more of Examples 1-4, wherein the post-model validation guardrail implements a multi-level verification process comprising:
performing a first validation using computationally lightweight physical checks;
performing a second validation using first-order PDE derivatives based on the first validation passing; and
performing a third validation using second-order PDE derivatives based on the second validation passing.

In Example 6, the subject matter of any one or more of Examples 1-5, wherein the physical laws comprise at least one of mass conservation, momentum conservation, or geometric symmetry properties.

In Example 7, the subject matter of any one or more of Examples 1-6, wherein the machine learning model comprises a surrogate model for at least one of computational fluid dynamics, computational mechanics, or electromagnetics simulations.

In Example 8, the subject matter of any one or more of Examples 1-7, wherein the processing circuitry is further to implement a correction model separate from the machine learning model and use the correction model to adjust outputs of the machine learning model based on the simulation results.

In Example 9, the subject matter of any one or more of Examples 1-8, wherein the predetermined distribution range is configurable based on user-specified accuracy requirements.

In Example 10, the subject matter of any one or more of Examples 1-9, wherein the processing circuitry is further to:
log validation results from both the pre-model validation guardrail and the post-model validation guardrail; and
provide validation notifications to a user.

### EXAMPLE SET 3

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is one or more processors comprising processing circuitry to:
receive output data from a machine learning model that processes input geometric data;
compute normalized partial differential equation (PDE) residuals from the output data, wherein the normalized PDE residuals quantify adherence of the output data to physical laws;
determine whether the normalized PDE residuals exceed predetermined thresholds; and
selectively validate the output data based on the determination of whether the normalized PDE residuals exceed the predetermined thresholds.

In Example 2, the subject matter of Example 1, wherein the processing circuitry is further to implement a multi-level verification process comprising:
performing a first validation using computationally lightweight physical checks;
performing a second validation using first-order PDE derivatives based on the first validation passing; and
performing a third validation using second-order PDE derivatives based on the second validation passing.

In Example 3, the subject matter of any one or more of Examples 1-2, wherein the physical laws comprise at least one of mass conservation, momentum conservation, or geometric symmetry properties.

In Example 4, the subject matter of any one or more of Examples 1-3, wherein the processing circuitry is further to, upon determining that the normalized PDE residuals exceed the predetermined thresholds:
route the input geometric data to a simulation service;
generate, by the simulation service, simulation results; and
use the simulation results to fine-tune the machine learning model.

In Example 5, the subject matter of any one or more of Examples 1-4, wherein the processing circuitry is further to implement a correction model separate from the machine learning model and use the correction model to adjust the output data based on the simulation results.

In Example 6, the subject matter of any one or more of Examples 1-5, wherein the machine learning model comprises a surrogate model for at least one of computational fluid dynamics, computational mechanics, or electromagnetics simulations.

In Example 7, the subject matter of any one or more of Examples 1-6, wherein the predetermined thresholds are configurable based on user-specified accuracy requirements.

In Example 8, the subject matter of any one or more of Examples 1-7, wherein the processing circuitry is further to:
log validation results; and
provide validation notifications to a user.

In Example 9, the subject matter of any one or more of Examples 1-8, wherein computing the normalized PDE residuals comprises:
substituting the output data into governing equations of a physical system being modeled;
calculating residual values that indicate deviation from the governing equations; and
normalizing the residual values to enable consistent interpretation across different scales or parameter regimes.

In Example 10, the subject matter of any one or more of Examples 1-9, wherein the processing circuitry is further to:
implement an ensemble-based uncertainty estimation component to provide additional insight into confidence of predictions in the output data; and
use results from the ensemble-based uncertainty estimation component in combination with the normalized PDE residuals to validate the output data.

What is claimed is:

1. One or more processors comprising processing circuitry to perform operations comprising:
processing training data comprising geometric shapes to generate shape-based distance metrics;
validating input geometric data for a machine learning model by comparing shape-based characteristics of the input geometric data against the shape-based distance metrics to determine that the input geometric data falls within a distribution range of the training data; and
in response to validating the input geometric data, processing the input geometric data using the machine learning model.

2. The one or more processors of claim 1, wherein the operations further comprise processing output data from the machine learning model by computing normalized partial differential equation (PDE) residuals that quantify adherence to physical laws.

3. The one or more processors of claim 2, wherein the operations further comprise implementing a dual guardrail framework that includes:
a pre-model validation using the shape-based distance metrics to detect out-of-distribution inputs; and
a post-model validation using the normalized PDE residuals to quantify the adherence to at least one physical law.

4. The one or more processors of claim 3, wherein the operations further comprise, in response to at least one of a pre-model validation failure indication or a post-model validation failure indication:
routing the input geometric data to a simulation service;
generating, by the simulation service, simulation results; and
using the simulation results generated by the simulation service, fine-tuning the machine learning model.

5. The one or more processors of claim 4, wherein fine-tuning the machine learning model comprises implementing a prediction-correction scheme that maintains the machine learning model while training a separate correction model.

6. The one or more processors of claim 3, wherein the post-model validation comprises multiple validation levels performed in order of increasing computational complexity.

7. The one or more processors of claim 1, wherein processing the training data to generate the shape-based distance metrics comprises:
converting the geometric shapes into point cloud representations;
performing nearest-neighbor mapping between the points; and
computing average distances between mapped points

8. The one or more processors of claim 1, wherein comparing shape-based characteristics comprises:
converting the input geometric data into a lower-dimensional latent space representation using a neural encoder; and
comparing the lower-dimensional latent space representation against encoded representations of the training data.

9. The one or more processors of claim 8, wherein the neural encoder comprises an autoencoder neural network that compresses high-dimensional geometric data into the lower-dimensional latent space representation.

10. The one or more processors of claim 1, wherein the distribution range is configurable based on user-specified accuracy requirements.

11. The one or more processors of claim 1, wherein the geometric shapes comprise a three-dimensional representation of at least one of:
a semiconductor cooling structure for thermal management;
an aircraft component for aerodynamic performance analysis;
an automotive body component for drag reduction analysis;
a product prototype for structural analysis;
a manufacturing tool for process simulation;
a material structure for property analysis; or
a multi-physics system for coupled phenomena simulation.

12. . The one or more processors of claim 1, wherein the operations further comprise implementing a correction model that is separate from the machine learning model and using the correction model to adjust outputs of the machine learning model.

13. The one or more processors of claim 1, wherein the operations further comprise implementing an ensemble uncertainty analysis to provide statistical confidence measures for predictions generated by the machine learning model.

14. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more small language models (SLMs);
a system implementing one or more vision language models (VLMs);
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

15. A method performed by a computing system comprising one or more processors, the method comprising:
accessing geometric input data for processing by a machine learning model;
comparing shape-based characteristics of the geometric input data to shape-based distance metrics derived from training data;
determining whether the geometric input data falls within a distribution range of the training data based on the comparing of the shape-based characteristics of the geometric input data to the shape-based distance metrics derived from the training data;
in response to determining that the geometric input falls within the distribution range of the training data, processing the geometric input data using the machine learning model;
generating, based on the processing of the geometric input data, simulation predictions for a technical system; and
applying the simulation predictions to modify a design of the technical system.

16. The method of claim 15, further comprising:
computing normalized partial differential equation (PDE) residuals from output data of the machine learning model; and
verifying adherence of the output data to physical laws based on the normalized PDE residuals.

17. The method of claim 16, wherein verifying adherence comprises:
performing an initial validation using computationally lightweight physical checks;
performing a subsequent validation using first-order PDE derivatives responsive to the initial validation passing; and
performing a final validation using second-order PDE derivatives responsive to the subsequent validation passing.

18. The method of claim 15, further comprising:
in response to determining that the geometric input data falls outside the distribution range:
causing the geometric input data to be processed by a simulation service;
accessing simulation results generated by the simulation service; and
fine-tuning the machine learning model using the simulation results.

19. The method of claim 15, wherein the technical system comprises at least one of:
a semiconductor cooling system for thermal management;
an aerospace component for aerodynamic performance analysis;
an automotive design for drag reduction;
a product prototype for structural analysis;
a manufacturing tool for process simulation;
a material structure for property analysis; or
a multi-physics system for coupled phenomena simulation.

20. A system comprising one or more processors to perform operations comprising:
accessing geometric input data for processing by a machine learning model;
comparing shape-based characteristics of the geometric input data to shape-based distance metrics derived from training data;
determining whether the geometric input data falls within a distribution range of the training data based on the comparing of the shape-based characteristics of the geometric input data to the shape-based distance metrics derived from the training data; and
based on the determination, selectively processing the geometric input data using the machine learning model.
